(19) United States
(12) Patent Application Publication
(10) Pub. No.: US 2025/0273695 A1
(43) Pub. Date: Aug. 28, 2025

(54) BIMODAL NANOPOROUS CARBON SUPPORTS FOR FUEL CELL APPLICATIONS

(71) Applicant: The Board of Trustees of the Leland Stanford Junior University, Stanford, CA (US)

(72) Inventors: Marwa Atwa, Stanford, CA (US); Shicheng Xu, Stanford, CA (US); Xiaoan Li, Stanford, CA (US); Viola Birss, Stanford, CA (US); Friedrich B. Prinz, Stanford, CA (US)

(73) Assignee: The Board of Trustees of the Leland Stanford Junior University, Stanford, CA (US)

(21) Appl. No.: 19/030,197

(22) Filed: Jan. 17, 2025

Related U.S. Application Data
(63) Continuation of application No. PCT/US2023/070645, filed on Jul. 20, 2023.
(60) Provisional application No. 63/391,285, filed on Jul. 21, 2022.

(51) Int. Cl. H01M 4/86; H01M 4/88; H01M 4/92; H01M 8/10; H01M 8/1004

(52) U.S. Cl. CPC H01M 4/8626; H01M 4/8657; H01M 4/8867; H01M 4/92; H01M 8/1004; H01M 2008/1095

(57) ABSTRACT

Supported catalyst systems comprise a bimodal nanoporous support, the support comprising: a plurality of porous bodies connected by interconnecting structures, wherein the porous bodies have primary pores throughout their structures, the primary pores defined by a first average pore diameter; and wherein the spaces between the interconnected porous bodies define secondary pores having a second average pore diameter; and catalyst deposits (e.g., comprising Pt) within the primary pores. The first average pore diameter is less than or equal to 20 nm, and the second average pore diameter is greater than 20 nm. The supported catalyst system further comprises an ionomer deposited onto the supported catalyst system, wherein the ionomer is localized to the secondary pores and the exterior surfaces of the porous bodies and interconnecting structures but does not enter the primary pores or contact the catalyst deposits inside the primary pores.

### CROSS-REFERENCE

This application is a continuation of International Application No. PCT/US2023/070645, filed Jul. 20, 2023, which claims the benefit of U.S. Provisional Application No. 63/391,285, filed Jul. 21, 2022, the entire contents of which are hereby incorporated by reference in their entireties.

### FIELD

The present embodiments relate generally to energy storage, and more particularly to catalyst support systems comprising bimodal nanoporous carbon supports for fuel cell applications.

### BACKGROUND

Considerable research and development efforts are focused on reducing the world's reliance on fossil fuels while moving toward the implementation of renewable energy. However, mitigating the intermittency problem attending use of renewable energy sources necessitates development of energy storage technologies. Such technologies include electrochemical technologies (e.g., rechargeable batteries and capacitors), as well as chemical- and fuel-based technologies (e.g., green hydrogen, produced in electrolysis cells and then fed to a fuel cell, along with air, to efficiently generate clean electricity). Thus, substantial research efforts are underway to improve the activity and durability of these technologies via new electrodes and electrocatalysts having morphologies engineered at the nanoscale.

It is against this technological backdrop that the present Applicant sought a technological solution to these and other problems rooted in this technology.

### SUMMARY

The present embodiments relate generally to improving activity and durability of energy storage devices, and more particularly to methods and apparatuses for improving these and other characteristics of proton exchange membrane fuel cell (PEMFC) cathodes by creating an ordered supported catalyst support system with pores on at least two size scales. Some embodiments relate to eliminating an ionomer-catalyst poisoning effect. Some embodiments relate to mitigating catalyst nanoparticle dissolution during long hours of fuel cell operation.

In one aspect, which may be combined with any other aspect or embodiment, the present disclosure relates to a supported catalyst system, comprising: a bimodal porous support, the support comprising: a plurality of porous bodies connected by interconnecting structures, wherein the porous bodies have primary pores throughout their structures, the primary pores defined by a first average pore diameter; and wherein the spaces between the interconnected porous bodies define secondary pores having a second average pore diameter; and catalyst deposits within the primary pores.

In some embodiments, the catalyst deposits comprise one or more platinum group metals. In some embodiments, the catalyst deposits comprise Pt. In some embodiments, the catalyst deposits are deposited within the primary pores by atomic layer deposition (ALD).

In some embodiments, the first average pore diameter is less than or equal to 20 nm. In some embodiments, the first average pore diameter is 8 nm to 20 nm. In some embodiments, the first average pore diameter is 10 nm to 15 nm.

In some embodiments, the second average pore diameter is greater than 20 nm. In some embodiments, the second average pore diameter is 100 nm to 500 nm. In some embodiments, the second average pore diameter is 200 nm to 300 nm.

In some embodiments, the porous bodies have a diameter of 500 nm to 1.5 μm. In some embodiments, the primary pores within a porous body are interconnected and have an average neck diameter of 2 nm to 8 nm.

In some embodiments, the porous bodies comprise a carbonaceous material. In some embodiments, the interconnecting structures comprise a carbonaceous material. In some embodiments, the interconnecting structures comprise carbon fibers.

In some embodiments, the supported catalyst system further comprises an ionomer, wherein the ionomer does not contact the catalyst deposits inside the primary pores. In some embodiments, the ionomer is located on outer surfaces of the porous bodies and the interconnecting structures but not within the primary pores. In some embodiments, the ionomer comprises a tetrafluoroethylene-based fluoropolymer.

In some embodiments, the supported catalyst system has a surface area of greater than or equal to 500 mm²/g, determined by BET analysis. In some embodiments, the supported catalyst system has an average mass-normalized ORR activity (MA) of greater than or equal to 0.44 A/mgPt at 0.9 V.

In another aspect, which may be combined with any other aspect or embodiment, the present disclosure relates to a membrane electrode assembly, comprising: a gas diffusion layer; a polymer electrolyte membrane; and the supported catalyst system according to any of the embodiments disclosed herein, wherein the supported catalyst system is between the gas diffusion layer and the polymer electrolyte membrane.

In another aspect, which may be combined with any other aspect or embodiment, the present disclosure relates to a fuel cell, comprising a membrane electrode assembly, the membrane electrode assembly comprising: a gas diffusion layer; a polymer electrolyte membrane; and the supported catalyst system according to any of the embodiments disclosed herein, wherein the supported catalyst system is between the gas diffusion layer and the polymer electrolyte membrane.

In another aspect, which may be combined with any other aspect or embodiment, the present disclosure relates to a method of making a supported catalyst system, the method comprising: providing a bimodal porous support, the support comprising: a plurality of porous bodies connected by interconnecting structures, wherein the porous bodies have primary pores throughout their structures, the primary pores defined by a first average pore diameter; and wherein the spaces between the interconnected porous bodies define secondary pores having a second average pore diameter; and depositing catalyst deposits within the primary pores.

In some embodiments, the depositing is performed using atomic layer deposition.

In some embodiments, the catalyst deposits comprise one or more platinum group metals. In some embodiments, the catalyst deposits comprise Pt.

In some embodiments, the first average pore diameter is less than or equal to 20 nm. In some embodiments, the first average pore diameter is 8 nm to 20 nm. In some embodiments, the first average pore diameter is 10 nm to 15 nm.

In some embodiments, the second average pore diameter is greater than 20 nm. In some embodiments, the second average pore diameter is 100 nm to 500 nm. In some embodiments, the second average pore diameter is 200 nm to 300 nm.

In some embodiments, the porous bodies have a diameter of 500 nm to 1.5 μm. In some embodiments, the primary pores within a porous body are interconnected and have an average neck diameter of 2 nm to 8 nm.

In some embodiments, the porous bodies comprise a carbonaceous material. In some embodiments, the interconnecting structures comprise a carbonaceous material. In some embodiments, the interconnecting structures comprise carbon fibers.

In some embodiments, the supported catalyst system further comprises an ionomer, wherein the ionomer does not contact the catalyst deposits inside the primary pores. In some embodiments, the ionomer is located on outer surfaces of the porous bodies and the interconnecting structures but not within the primary pores. In some embodiments, the ionomer comprises a tetrafluoroethylene-based fluoropolymer.

In some embodiments, the supported catalyst system has a surface area of greater than or equal to 500 mm²/g, determined by BET analysis. In some embodiments, the supported catalyst system has an average mass-normalized ORR activity (MA) of greater than or equal to 0.44 A/mgPt at 0.9 V.

Additional aspects and/or embodiments of the present technology will be provided, without limitation, in the detailed description of the present technology set forth below. The following detailed description is exemplary and explanatory, but it is not intended to be limiting.

### BRIEF DESCRIPTION OF THE DRAWINGS

Various objects, aspects, features, and advantages of the disclosure will become more apparent and better understood by referring to the Detailed Description taken in conjunction with the accompanying Figures, wherein:

FIGS. 1A-1E show morphological and pore characteristics of self-supported ‘ball-and-stick’ NCS12 films. FIG. 1A is a FESEM top-down image of NCS12 film. FIG. 1B is a photograph of an analogous Craspedia flower structure. FIG. 1C shows, from top to bottom: FESEM images of the cross-section of a 18-μm thick NCS12 film at low magnification; a higher-magnification image of a NCS12 sphere; and a more highly magnified image of the ordered 12 nm pores within the spheres. FIG. 1D shows pore size distribution (PDS) of NCS12 films obtained from the N₂ gas sorption isotherm (BJH method) using the absorption branch to determine average pore diameter. FIG. 1E shows average pore neck size distribution (PDS) of NCS12 films obtained from the N₂ gas sorption isotherm (BJH method) using the desorption branch.

FIGS. 2A-2G show design and characterization of an ALD Ptx/NCS12 membrane catalyst layer with Pt inside the 12 nm pores within the spheres and NAFION™ present only on outer sphere surfaces. FIG. 2A is a schematic illustration of the steps required to first load Pt using one or more ALD cycles and then infiltrate NAFION™ into the NCS12 membrane. FIG. 2B shows a high annular dark-field scanning transmission electron microscope (HAADF-STEM) image of a Pt10/NCS12 membrane. FIG. 2C shows a Pt EDX map (green) of a sphere within a Pt10/NCS12 membrane. FIG. 2D is a HAADF-STEM image of a cross-sectional sample of a Pt10/NCS12 film, showing the rich presence and excellent distribution of Pt NPs within the 12 nm pores inside the spheres. FIG. 2E is a HAADF-STEM micrograph of 100 nm microtomed slice of the Pt10/NCS12 catalyst layer in an MEA, showing its microstructure of the catalyst layer. FIG. 2F shows a fluorine EDX map (blue) showing the NAFION™ distribution on only the outer sphere surfaces within a cross-sectional Pt10/NCS12 membrane. FIG. 2G shows cyclic voltammetry (CVs) (20 mV/s, 100% humidified Ar at 80° C.) of Ptx/NCS12 (where x=7, 10 and 20) and a Pt10/NCS85 membrane, as well as a state-of-the-art Pt/C powder-based catalyst (see M. Atwa et al., Scalable Nanoporous Carbon Films Allow Line-of-sight 3D Atomic Layer Deposition of Pt: Towards a New Generation Catalyst Layer for PEM Fuel Cells, 8 MATER. HORIZONS 2451-62 (2021)), all in an MEA in H₂/Ar at 80° C. and at 100% RH.

FIGS. 3A-3D show electrochemical performance of self-supported Pt10/NCSy catalyst layers in PEMFC MEA. FIG. 3A shows an IR-corrected H₂/O₂ mass activities of state-of-the-art Pt/C and Pt10/NCS catalyst layers, carried out at 100% RH, 150 kPa_{abs}, and 80° C. FIG. 3B shows average mass activity of Pt10/NCS12, Pt10/NCS85, and state-of-the-art Pt/C powder catalyst layers measured in an MEA at 0.9 V. FIGS. 3C and 3D show cyclic voltammograms (20 mV/s, humidified H₂/Ar at 80° C.) of Pt10/NCS12 (FIG. 3C) and Pt10/NCS85 (FIG. 3D) catalyst layers, measured at RH values of 30%, 50%, 80%, and 100%.

FIGS. 4A-4F show durability of an ALD-Pt10/NCS12 catalyst layer after ADT. FIG. 4A shows H₂/O₂ mass activity of P10/NCS12 at “beginning of life” (BOL) and “end of life (EOL), collected after 10,000 square-wave cycles between 0.6 V and 0.95 V, with 3 second holds at each potential. FIG. 4B shows IR-corrected H₂/air performance of MEAs of P10/NCS12 at BOL and EOL, carried out in 100% RH, 150 kPa_{abs}, and 80° C. FIG. 4C shows an annular dark-field TEM image of a Pt10/NCS12 catalyst layer at BOL. FIG. 4D shows Pt EDX mapping of Pt10/NCS12 catalyst layer in MEA at BOL. FIG. 4E shows an annular dark-field TEM image of a Pt10/NCS12 catalyst layer at EOL. FIG. 4F shows Pt EDX mapping of a Pt10/NCS12 catalyst layer in MEA at EOL.

FIG. 5 shows size distribution of Craspedia-like spheres within NCS12, determined from the FESEM cross-sectional image in FIG. 1C.

FIG. 6A shows a cross-sectional FESEM image (top) and a top-down FESEM image (bottom) of NCS50. FIG. 6B shows a cross-sectional FESEM image (top) and a top-down FESEM image (bottom) of NCS85.

FIGS. 7A-7D show a schematic showing the process for forming the ball-and-stick microstructure of a NCS12 film.

FIGS. 8A-8B shows top-down FESEM images of two different NCS-12 films prepared using different processing conditions to have different microstructures.

FIG. 9 shows a N₂ gas sorption isotherm of a NCS12 film.

FIG. 10A shows a cross-sectional SEM image of PT7/NCS12. FIG. 10B shows Pt EDX maps of Pt7/NCS12. FIG. 10C shows a cross-sectional SEM image of PT10/NCS12. FIG. 10D shows Pt EDX maps of Pt10/NCS12.

FIGS. 11A-11D show backscattered electron images (BEIs) and bright field (BF) STEM images of the same area of Craspedia-like spheres within a microtomed Pt10/NCS12 catalyst layer thin section, obtained from a MEA after testing. FIG. 11A and FIG. 11B are BEI-STEM images showing Pt NPs (bright spots) deposited on the external surfaces of the spheres. FIG. 11C and FIG. 11D are BF-STEM images showing Pt NPs (dark spots) on both the external and inner surfaces of the microtomed slices of the spheres.

FIGS. 12A-12D show TEM images of 100 nm microtomed slices of a Pt10/NCS12 film at different magnifications. FIG. 12A is a TEM image of a cross-section of multiple spheres within one specimen. FIG. 12B is a TEM image of a single sphere. FIG. 12C is a TEM image at the center of the sphere marked as “A” in FIG. 12B. FIG. 12D is a high magnification TEM image of the area shown in FIG. 1C, showing highly uniform Pt nanoparticles (black dots) distributed inside one of the NCS12 spheres.

FIGS. 13A-13D show high magnification TEM images with histograms of Pt NP size distribution for Ptx/NCS12 films: Pt7/NCS12 (FIG. 13A); Pt10/NCS12 (FIG. 13B); Pt15/NCS12 (FIG. 13C); and Pt20/NCS12 (FIG. 13D).

FIG. 14 shows cyclic voltammograms (20 mV/s, 100% humidified Ar, 80° C.) of Ptx/NCS12, Pt10/NCS85, and state-of-the-art Pt/C powder-based catalysts in a MEA in H₂/Ar.

FIG. 15 shows IR-corrected H₂/O₂ specific activities of state-of-the-art Pt/C and ALD-Ptx/NCSy catalyst layers tested in a MEA in 100% RH, at 150 kPa_{abs} and 80° C.

FIG. 16A shows a TEM image of Pt10/NCS85. FIG. 16B shows a Pt NP size distribution in Pt10/NCS85 films.

FIG. 17A shows a curve-fitted high-resolution X-ray photoelectron spectrum for the O1s region of NCS12. FIG. 17B shows a curve-fitted high-resolution X-ray photoelectron spectrum for the C1s region of NCS12. FIG. 17C shows CV of NCS12 in 0.5 M H₂SO₄ at 10 mV/s. FIG. 17D shows a contact angle measurement for bare NCS12 in deionized water.

FIG. 18A shows a high-magnification TEM image near the surface of a Pt-loaded Pt10/NCS12 sphere at EOL after testing at 100% RH and 80° C. FIG. 18B shows a HR-TEM image near the surface of a NCS12 sphere. FIG. 18C shows a HR-TEM image near the center of a NCS12 sphere. FIG. 18D shows Pt nanoparticle size distribution in the region shown in FIG. 18B. FIG. 18E shows Pt nanoparticle size distribution in the region shown in FIG. 18C.

FIG. 19A shows EDS mapping of fluorine for Pt10/NCS12 in a MEA at EOL. FIG. 19B shows a HAADF-STEM image of Pt10/NCS12 in a MEA at EOL. FIG. 19C shows an EDX line scan of the Pt (green) and F (blue) of the catalyst layer in FIG. 19B.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

The present disclosure set out to determine the effect of restricting the interactions between Pt nanoparticle (NP) catalysts and a NAFION™ ionomer in the cathode catalyst layer of a proton exchange membrane fuel cell (PEMFC) on the oxygen reduction reaction (ORR) kinetics. While NAFION™ is considered to be essential for proton transport to Pt to carry out the ORR, the sulfonate groups on NAFION™ can also specifically adsorb on Pt surfaces and compromise the reaction kinetics. Furthermore, if NAFION™ coats the Pt NPs, this leads to a gas-ionomer interface resistance for the mass transport of oxygen, with its magnitude depending on the thickness of the NAFION™ layer. These trade-offs indicate that an optimal catalyst/ionomer micro-environment is needed.

To achieve this goal, developed was a bimodal nanoporous carbon membrane, namely a self-supported ball-and-stick sheet, loaded with metal catalyst nanoparticles (NPs), e.g., Pt NPs, using atomic layer deposition (ALD) and infiltration with NAFION™. By limiting the number of ALD cycles used, the vast majority of the Pt NPs can be constrained to be inside the ordered 12 nm pores within the ˜1 μm diameter porous bodies (e.g., “balls” or spheres), while NAFION™ coats and interconnects the spheres but cannot penetrate them due to size exclusion. This new morphology exhibits unexpectedly high oxygen reduction mass activity (1.3 times the current DOE target) as well as remarkable durability in a PEM fuel membrane-electrode-assembly test. This is attributed to the shielding of the NPs from direct contact and poisoning by NAFION™ while also protecting the NPs from migration, resulting in almost no loss of kinetics after accelerated durability testing. Without being bound to any particular theory, proton transport to the Pt NPs inside the 12 nm pores may occur via a water layer that is stabilized by the unusually high surface density of oxygen functional groups on the carbon scaffold surface.

The approach used in this work to nanoengineer the catalyst layer morphology to optimize the Pt/ionomer environment opens a new dimension for controlling interactions between ionically conducting phases and electrocatalysts for a range of other electrochemical applications. Some examples include oxygen reduction in metal/air batteries and electrochemical CO₂ reduction in MEA testing, where the electrocatalysts must be in close proximity to water or an ionically conducting polymer while, at the same time, the catalyst layer must remain hydrophobic overall, usually achieved by the presence of Teflon. The ball-and-stick nanostructure should also be ideal for flow battery applications, with the smaller mesopores housing the electrocatalysts and the secondary pores allowing unimpeded liquid flow through the electrode.

### Porous Bodies

Bimodal nanoporous carbon supports according to the present disclosure comprise porous bodies interconnected by interconnecting structures. The overall structure of porous bodies and interconnecting structures may be a “ball-and-stick” structure, in which interconnecting structures (“sticks”) connect the porous bodies (which may be roughly spherical). The porous bodies may have primary pores throughout their structures (e.g., throughout their entire 3D structure), as opposed to having pores localized to their surfaces.

The porous bodies may comprise any suitable material for hosting a catalyst and/or facilitating a catalytic reaction (e.g., ORR). In some embodiments, the porous bodies comprise a carbonaceous material (e.g., amorphous carbon, graphene, graphite, polymers, carbon-containing materials derived from heat-treated polymers, such as PVA, etc.). However, other materials (e.g., metals, metal oxides, metal carbides, metal nitrides, etc.) are possible.

The porous bodies may have any suitable size for hosting a catalyst material and/or facilitating a catalytic reaction (e.g., ORR). In some embodiments, the porous bodies have an average diameter of greater than or equal to about 200 nm, greater than or equal to about 250 nm, greater than or equal to about 300 nm, greater than or equal to about 350 nm, greater than or equal to about 400 nm, greater than or equal to about 450 nm, greater than or equal to about 500 nm, greater than or equal to about 550 nm, greater than or equal to about 600 nm, greater than or equal to about 650 nm, greater than or equal to about 700 nm, greater than or equal to about 750 nm, greater than or equal to about 800 nm, greater than or equal to about 850 nm, greater than or equal to about 900 nm, greater than or equal to about 950 nm, greater than or equal to about 1 μm, greater than or equal to about 1.1 μm, greater than or equal to about 1.2 μm, greater than or equal to about 1.3 μm, greater than or equal to about 1.4 μm, greater than or equal to about 1.5 μm, greater than or equal to about 1.6 μm, greater than or equal to about 1.7 μm, greater than or equal to about 1.8 μm, greater than or equal to about 1.9 μm, greater than or equal to about 2 μm, greater than or equal to about 3 μm, greater than or equal to about 4 μm, greater than or equal to about 5 μm, or any range or value therein between.

In some embodiments, the porous bodies have an average diameter of less than or equal to about 5 μm, less than or equal to about 4 μm, less than or equal to about 3 μm, less than or equal to about 2 μm, less than or equal to about 1.9 μm, less than or equal to about 1.8 μm, less than or equal to about 1.7 μm, less than or equal to about 1.6 μm, less than or equal to about 1.5 μm, less than or equal to about 1.4 μm, less than or equal to about 1.3 μm, less than or equal to about 1.2 μm, less than or equal to about 1.1 μm, less than or equal to about 1 μm, less than or equal to about 950 nm, less than or equal to about 900 nm, less than or equal to about 850 nm, less than or equal to about 800 nm, less than or equal to about 750 nm, less than or equal to about 700 nm, less than or equal to about 650 nm, less than or equal to about 600 nm, less than or equal to about 550 nm, less than or equal to about 500 nm, less than or equal to about 450 nm, less than or equal to about 400 nm, less than or equal to about 350 nm, less than or equal to about 300 nm, less than or equal to about 250 nm, or any range or value therein between.

In some embodiments, the porous bodies have an average diameter of 100 nm to 5 μm, 100 nm to 2 μm, 100 nm to 1.5 μm, 100 nm to 1 μm, 100 nm to 900 nm, 100 nm to 800 nm, 100 nm to 700 nm, 100 nm to 600 nm, 100 nm to 500 nm, 250 nm to 5 μm, 250 nm to 2 μm, 250 nm to 1.5 μm, 250 nm to 1 μm, 250 nm to 900 nm, 250 nm to 800 nm, 250 nm to 700 nm, 250 nm to 600 nm, 250 nm to 500 nm, 500 nm to 5 μm, 500 nm to 4 μm, 500 nm to 3 μm, 500 nm to 2.5 m, 500 nm to 2 μm, 500 nm to 1.5 μm, 500 nm to 1 μm, 500 nm to 900 nm, 500 nm to 800 nm, 500 nm to 700 nm, or any range or value therein between.

In some embodiments, the porous bodies are roughly spherical. In some embodiments, the porous bodies may be non-spherical (e.g., cylindrical) and have a primary axis with a first diameter and a secondary axis with a second diameter larger than the first diameter. In such embodiments, the average diameter of the porous bodies may be considered to be either the first diameter or the second diameter. In some embodiments, the porous bodies may be irregularly shaped. In such embodiments, the average diameter may be considered to be the average diameter of a circle encompassing an irregularly shaped porous body, e.g., when viewed from the top-down in a TEM image or SEM image.

### Primary Pores

Bimodal nanoporous carbon supports according to the present disclosure comprise porous bodies having interconnected pores (primary pores) throughout their 3D structures. The primary pores may have any suitable size for hosting a catalyst material and/or facilitating a catalytic reaction (e.g., ORR). The primary pores may be any suitable size for excluding chemical species (e.g., ionomers) that may hinder or prevent catalysis or cause catalyst poisoning when in contact with the catalyst deposits.

In some embodiments, the primary pores may have an average diameter of less than or equal to about 50 nm, less than or equal to about 45 nm, less than or equal to about 40 nm, less than or equal to about 35 nm, less than or equal to about 30 nm, less than or equal to about 25 nm, less than or equal to about 20 nm, less than or equal to about 19 nm, less than or equal to about 18 nm, less than or equal to about 17 nm, less than or equal to about 16 nm, less than or equal to about 15 nm, less than or equal to about 14 nm, less than or equal to about 13 nm, less than or equal to about 12 nm, less than or equal to about 11 nm, less than or equal to about 10 nm, less than or equal to about 9 nm, less than or equal to about 8 nm, less than or equal to about 7 nm, less than or equal to about 6 nm, less than or equal to about 5 nm, or any range or value therein between.

In some embodiments, the primary pores have an average diameter of greater than or equal to about 5 nm, greater than or equal to about 6 nm, greater than or equal to about 7 nm, greater than or equal to about 8 nm, greater than or equal to about 9 nm, greater than or equal to about 10 nm, greater than or equal to about 11 nm, greater than or equal to about 12 nm, greater than or equal to about 13 nm, greater than or equal to about 14 nm, greater than or equal to about 15 nm, greater than or equal to about 16 nm, greater than or equal to about 17 nm, greater than or equal to about 18 nm, greater than or equal to about 19 nm, greater than or equal to about 20 nm, or any range or value therein between.

In some embodiments, the primary pores may have an average diameter of 5 nm to 50 nm, 5 nm to 40 nm, 5 nm to 30 nm, 5 nm to 25 nm, 5 nm to 20 nm, 5 nm to 18 nm, 5 nm to 15 nm, 5 nm to 12 nm, 5 nm to 10 nm, 8 nm to 50 nm, 8 nm to 40 nm, 8 nm to 30 nm, 8 nm to 25 nm, 8 nm to 20 nm, 8 nm to 18 nm, 8 nm to 15 nm, 8 nm to 12 nm, 10 nm to 50 nm, 10 nm to 40 nm, 10 nm to 30 nm, 10 nm to 25 nm, 10 nm to 20 nm, 10 nm to 18 nm, 10 nm to 15 nm, 10 nm to 12 nm, or any range or value therein between.

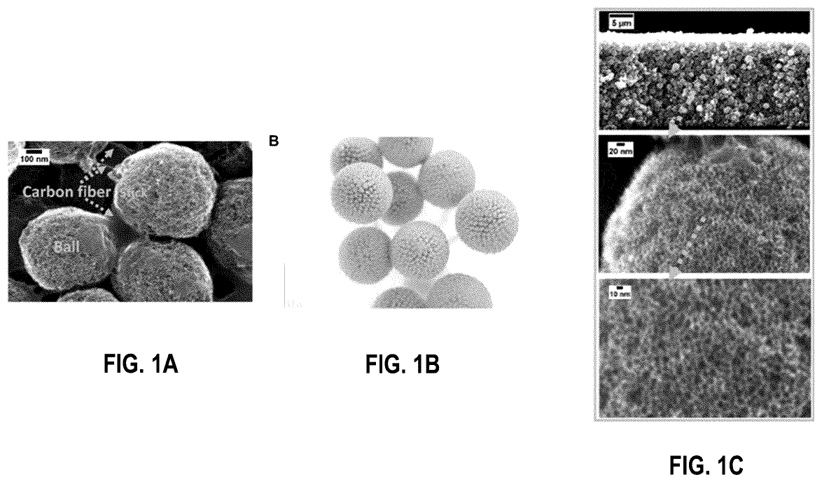

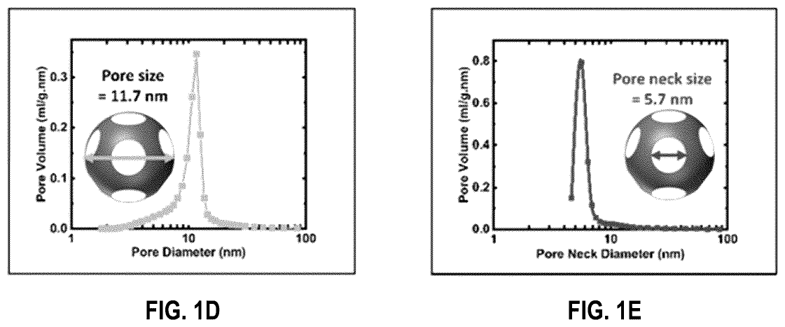

The primary pores are interconnected throughout each porous body, and the openings “necks” between adjacent pores (see FIG. 1D) may be any suitable size for permitting deposition of a catalyst material throughout the porous body and/or facilitating a catalytic reaction (e.g., ORR) by allowing electron transport between primary pores while excluding chemical species (e.g., ionomers) that may hinder or prevent catalysis or cause catalyst poisoning when in contact with the catalyst deposits.

In some embodiments, the primary pores have an average neck diameter of less than or equal to about 20 nm, less than or equal to about 19 nm, less than or equal to about 18 nm, less than or equal to about 17 nm, less than or equal to about 16 nm, less than or equal to about 15 nm, less than or equal to about 14 nm, less than or equal to about 13 nm, less than or equal to about 12 nm, less than or equal to about 11 nm, less than or equal to about 10 nm, less than or equal to about 9 nm, less than or equal to about 8 nm, less than or equal to about 7 nm, less than or equal to about 6 nm, less than or equal to about 5 nm, less than or equal to about 4 nm, less than or equal to about 3 nm, less than or equal to about 2 nm, or any range or value therein between.

In some embodiments, the primary pores have an average neck diameter of greater than or equal to about 2 nm, greater than or equal to about 3 nm, greater than or equal to about 4 nm, greater than or equal to about 5 nm, greater than or equal to about 6 nm, greater than or equal to about 7 nm, greater than or equal to about 8 nm, greater than or equal to about 9 nm, greater than or equal to about 10 nm, greater than or equal to about 11 nm, greater than or equal to about 12 nm, greater than or equal to about 13 nm, greater than or equal to about 14 nm, greater than or equal to about 15 nm, greater than or equal to about 16 nm, greater than or equal to about 17 nm, greater than or equal to about 18 nm, greater than or equal to about 19 nm, greater than or equal to about 20 nm, or any range or value therein between.

In some embodiments, the primary pores have an average neck diameter of 2 nm to 20 nm, 2 nm to 18 nm, 2 nm to 15 nm, 2 nm to 12 nm, 2 nm to 10 nm, 2 nm to 8 nm, 2 nm to 5 nm, 3 nm to 20 nm, 3 nm to 18 nm, 3 nm to 15 nm, 3 nm to 12 nm, 3 nm to 10 nm, 3 nm to 8 nm, 3 nm to 5 nm, 5 nm to 20 nm, 5 nm to 18 nm, 5 nm to 15 nm, 5 nm to 12 nm, 5 nm to 10 nm, 5 nm to 8 nm, or any range or value therein between.

### Interconnecting Structures

Bimodal nanoporous carbon supports according to the present disclosure comprise porous bodies interconnected by interconnecting structures. The overall structure of porous bodies and interconnecting structures may be a “ball-and-stick” structure, in which interconnecting structures (“sticks”) connect the porous bodies (which may be roughly spherical).

The interconnecting structures may comprise any material suitable for providing stable structural support to the overall bimodal support and for connecting the porous bodies. In some embodiments, the interconnecting structures comprise a carbonaceous material (e.g., carbon fibers, graphene, graphite, carbon nanorods, carbon nanotubes, polymers, etc.). In some embodiments, the interconnecting structures may comprise metal oxides, metal carbide, metal nitrides, or any other suitable material, which may be coated with a carbonaceous material (e.g., carbon fibers, graphene, graphite, carbon nanorods, carbon nanotubes, amorphous carbon, polymers, etc.).

In some embodiments, the interconnecting structures have an average length of greater than or equal to about 50 nm, greater than or equal to about 100 nm, greater than or equal to about 150 nm, greater than or equal to about 200 nm, greater than or equal to about 250 nm, greater than or equal to about 300 nm, greater than or equal to about 350 nm, greater than or equal to about 400 nm, greater than or equal to about 450 nm, greater than or equal to about 500 nm, greater than or equal to about 550 nm, greater than or equal to about 600 nm, greater than or equal to about 650 nm, greater than or equal to about 700 nm, greater than or equal to about 750 nm, greater than or equal to about 800 nm, greater than or equal to about 850 nm, greater than or equal to about 900 nm, greater than or equal to about 950 nm, greater than or equal to about 1 μm, greater than or equal to about 1.1 μm, greater than or equal to about 1.2 μm, greater than or equal to about 1.3 μm, greater than or equal to about 1.4 μm, greater than or equal to about 1.5 μm, greater than or equal to about 1.6 μm, greater than or equal to about 1.7 μm, greater than or equal to about 1.8 μm, greater than or equal to about 1.9 μm, greater than or equal to about 2 μm, greater than or equal to about 3 μm, greater than or equal to about 4 μm, greater than or equal to about 5 μm, or any range or value therein between.

In some embodiments, the interconnecting structures have an average length of less than or equal to about 5 μm, less than or equal to about 4 μm, less than or equal to about 3 μm, less than or equal to about 2 μm, less than or equal to about 1 μm, less than or equal to about 950 nm, less than or equal to about 900 nm, less than or equal to about 850 nm, less than or equal to about 800 nm, less than or equal to about 750 nm, less than or equal to about 700 nm, less than or equal to about 650 nm, less than or equal to about 600 nm, less than or equal to about 550 nm, less than or equal to about 500 nm, less than or equal to about 450 nm, less than or equal to about 400 nm, less than or equal to about 350 nm, less than or equal to about 300 nm, less than or equal to about 250 nm, less than or equal to about 200 nm, less than or equal to about 150 nm, less than or equal to about 100 nm, less than or equal to about 50 nm, or any range or value therein between.

In some embodiments, the interconnecting structures have an average diameter less than the average diameter of the porous bodies.

### Secondary Pores

The length and arrangement of the interconnecting structures in combination with the porous bodies defines secondary pores between the porous bodies. The secondary pores are interconnected throughout the bimodal nanoporous support.

The secondary pores may have any suitable size for hosting an electron-conducting material (e.g., one or more ionomers) and/or a catalyst material that facilitate a catalytic reaction (e.g., ORR). In some embodiments, the secondary pores have an average diameter of greater than or equal to about 20 nm, greater than or equal to about 30 nm, greater than or equal to about 40 nm, greater than or equal to about 50 nm, greater than or equal to about 60 nm, greater than or equal to about 70 nm, greater than or equal to about 80 nm, greater than or equal to about 90 nm, greater than or equal to about 100 nm, greater than or equal to about 125 nm, greater than or equal to about 150 nm, greater than or equal to about 175 nm, greater than or equal to about 200 nm, greater than or equal to about 250 nm, greater than or equal to about 300 nm, greater than or equal to about 350 nm, greater than or equal to about 400 nm, greater than or equal to about 450 nm, greater than or equal to about 500 nm, greater than or equal to about 550 nm, greater than or equal to about 600 nm, greater than or equal to about 650 nm, greater than or equal to about 700 nm, greater than or equal to about 750 nm, greater than or equal to about 800 nm, greater than or equal to about 850 nm, greater than or equal to about 900 nm, greater than or equal to about 950 nm, greater than or equal to about 1 μm, greater than or equal to about 1.1 μm, greater than or equal to about 1.2 μm, greater than or equal to about 1.3 μm, greater than or equal to about 1.4 μm, greater than or equal to about 1.5 μm, greater than or equal to about 1.6 m, greater than or equal to about 1.7 μm, greater than or equal to about 1.8 μm, greater than or equal to about 1.9 μm, greater than or equal to about 2 μm, greater than or equal to about 3 μm, greater than or equal to about 4 μm, greater than or equal to about 5 μm, or any range or value therein between.

In some embodiments, the secondary pores have an average diameter of less than or equal to about 5 μm, less than or equal to about 4 μm, less than or equal to about 3 μm, less than or equal to about 2 μm, less than or equal to about 1.9 μm, less than or equal to about 1.8 μm, less than or equal to about 1.7 μm, less than or equal to about 1.6 μm, less than or equal to about 1.5 μm, less than or equal to about 1.4 μm, less than or equal to about 1.3 μm, less than or equal to about 1.2 μm, less than or equal to about 1.1 μm, less than or equal to about 1 μm, less than or equal to about 950 nm, less than or equal to about 900 nm, less than or equal to about 850 nm, less than or equal to about 800 nm, less than or equal to about 750 nm, less than or equal to about 700 nm, less than or equal to about 650 nm, less than or equal to about 600 nm, less than or equal to about 550 nm, less than or equal to about 500 nm, less than or equal to about 450 nm, less than or equal to about 400 nm, less than or equal to about 350 nm, less than or equal to about 300 nm, less than or equal to about 250 nm, less than or equal to about 200 nm, less than or equal to about 175 nm, less than or equal to about 150 nm, less than or equal to about 125 nm, less than or equal to about 100 nm, less than or equal to about 90 nm, less than or equal to about 80 nm, less than or equal to about 70 nm, less than or equal to about 60 nm, less than or equal to about 50 nm, less than or equal to about 40 nm, less than or equal to about 30 nm, or any range or value therein between.

In some embodiments, the secondary pores have an average diameter of 20 nm to 5 μm, 20 nm to 1 μm, 20 nm to 800 nm, 20 nm to 500 nm, 20 nm to 250 nm, 50 nm to 5 μm, 50 nm to 1 μm, 50 nm to 800 nm, 50 nm to 500 nm, 50 nm to 250 nm, 100 nm to 5 μm, 100 nm to 1 μm, 100 nm to 800 nm, 100 nm to 500 nm, 100 nm to 250 nm, 200 nm to 5 μm, 200 nm to 1 μm, 200 nm to 800 nm, 200 nm to 500 nm, 200 nm to 300 nm, or any range or value therein between.

### Surface Area

The hierarchical nature of the bimodal nanoporous supports according to the present disclosure affords a high surface area to enhance catalytic reactions (e.g., ORR). In some embodiments, the bimodal nanoporous support has a surface area of greater than or equal to about 200 mm²/g, greater than or equal to about 250 mm²/g, greater than or equal to about 300 mm²/g, greater than or equal to about 350 mm²/g, greater than or equal to about 400 mm²/g, greater than or equal to about 450 mm²/g, greater than or equal to about 500 mm²/g, greater than or equal to about 550 mm²/g, greater than or equal to about 600 mm²/g, greater than or equal to about 650 mm²/g, greater than or equal to about 700 mm²/g, greater than or equal to about 750 mm²/g, greater than or equal to about 800 mm²/g, greater than or equal to about 850 mm²/g, greater than or equal to about 900 mm²/g, greater than or equal to about 950 mm²/g, or any range or value therein between.

In some embodiments, the outer surface area of the porous bodies (i.e., the surface area of the outermost surfaces of the porous bodies, not including the surface area of the primary pores within the support) makes up a small fraction of the overall surface area of the bimodal nanoporous support. In some embodiments, the outer surface area of the porous bodies makes up less than or equal to 10%, less than or equal to 9.5%, less than or equal to 9.0%, less than or equal to 8.5%, less than or equal to 8.0%, less than or equal to 7.5%, less than or equal to 7.0%, less than or equal to 6.5%, less than or equal to 6.0%, less than or equal to 5.5%, less than or equal to 5.0%, less than or equal to 4.5%, less than or equal to 4.0%, less than or equal to 3.5%, less than or equal to 3.0%, less than or equal to 2.5%, less than or equal to 2.0%, less than or equal to 1.5%, less than or equal to 1.0%, less than or equal to 0.9%, less than or equal to 0.8%, less than or equal to 0.7%, less than or equal to 0.6%, less than or equal to 0.5%, less than or equal to 0.4%, less than or equal to 0.3%, less than or equal to 0.2%, or less than or equal to 0.1% of the total surface area of the overall nanoporous support, or any range or value therein between.

In some embodiments, the inner surface area of the porous bodies (i.e., the surface area of the primary pores below the outermost surface of the porous body) makes up a large fraction of the overall surface area of the bimodal nanoporous support. In some embodiments, the inner surface area makes up greater than or equal to about 90%, greater than or equal to about 90.5%, greater than or equal to about 91%, greater than or equal to about 91.5%, greater than or equal to about 92%, greater than or equal to about 92.5%, greater than or equal to about 93%, greater than or equal to about 93.5%, greater than or equal to about 94%, greater than or equal to about 94.5%, greater than or equal to about 95%, greater than or equal to about 95.5%, greater than or equal to about 96%, greater than or equal to about 96.5%, greater than or equal to about 97%, greater than or equal to about 97.5%, greater than or equal to about 98%, greater than or equal to about 98.5%, greater than or equal to about 99%, greater than or equal to about 99.1%, greater than or equal to about 99.2%, greater than or equal to about 99.3%, greater than or equal to about 99.4%, greater than or equal to about 99.5%, greater than or equal to about 99.6%, greater than or equal to about 99.7%, greater than or equal to about 99.8%, or greater than or equal to about 99.9%, of the total surface area of the bimodal nanoporous support, or any range or value therein between.

### Catalyst Particles

Supported catalyst systems according to the present disclosure comprise bimodal porous supports comprising porous bodies having interconnected pores (primary pores) throughout their 3D structures. The primary pores may host catalyst materials deposited within the porous bodies.

The catalyst deposits may be introduced into the bimodal nanoporous support by any method known in the art, including by not limited to atomic layer deposition (ALD), sputtering, chemical vapor deposition, solution phase deposition, or any other suitable method. In some embodiments, the catalyst deposits are deposited within the primary pores using atomic layer deposition.

The catalyst deposits may be any suitable size and composition to facilitate a catalytic reaction (e.g., ORR). In some embodiments, the catalyst deposits comprise a metal, metal oxide, metal carbide, metal nitride, semiconductor, or any combination thereof. In some embodiments, the catalyst deposits comprise one or more transition metals (e.g., V, Cr, Mn, Fe, Co, Ni, Cu, Ru, Rh, Pd, Ag, Re, Os, Ir, Pt, Au, Hg, or any combination or oxide or alloy thereof). In some embodiments, the catalyst deposits comprise one or more platinum group metals (e.g., Ru, Rh, Pd, Os, Ir, Pt, or any alloy or oxide or combination thereof). In some embodiments, the catalyst deposits comprise Pt. In some embodiments, the catalyst deposits comprise Pt nanoparticles (Pt NPs).

In some embodiments, the catalyst deposits have an average size of greater than or equal to about 0.5 nm, greater than or equal to about 0.6 nm, greater than or equal to about 0.7 nm, greater than or equal to about 0.8 nm, greater than or equal to about 0.9 nm, greater than or equal to about 1.0 nm, greater than or equal to about 1.1 nm, greater than or equal to about 1.2 nm, greater than or equal to about 1.3 nm, greater than or equal to about 1.4 nm, greater than or equal to about 1.5 nm, greater than or equal to about 1.6 nm, greater than or equal to about 1.7 nm, greater than or equal to about 1.8 nm, greater than or equal to about 1.9 nm, greater than or equal to about 2.0 nm, greater than or equal to about 2.1 nm, greater than or equal to about 2.2 nm, greater than or equal to about 2.3 nm, greater than or equal to about 2.4 nm, greater than or equal to about 2.5 nm, greater than or equal to about 2.6 nm, greater than or equal to about 2.7 nm, greater than or equal to about 2.8 nm, greater than or equal to about 2.9 nm, greater than or equal to about 3.0 nm, greater than or equal to about 3.1 nm, greater than or equal to about 3.2 nm, greater than or equal to about 3.3 nm, greater than or equal to about 3.4 nm, greater than or equal to about 3.5 nm, greater than or equal to about 3.6 nm, greater than or equal to about 3.7 nm, greater than or equal to about 3.8 nm, greater than or equal to about 3.9 nm, greater than or equal to about 4.0 nm, greater than or equal to about 4.1 nm, greater than or equal to about 4.2 nm, greater than or equal to about 4.3 nm, greater than or equal to about 4.4 nm, greater than or equal to about 4.5 nm, greater than or equal to about 4.6 nm, greater than or equal to about 4.7 nm, greater than or equal to about 4.8 nm, greater than or equal to about 4.9 nm, greater than or equal to about 5.0 nm, greater than or equal to about 5.1 nm, greater than or equal to about 5.2 nm, greater than or equal to about 5.3 nm, greater than or equal to about 5.4 nm, greater than or equal to about 5.5 nm, greater than or equal to about 5.6 nm, greater than or equal to about 5.7 nm, greater than or equal to about 5.8 nm, greater than or equal to about 5.9 nm, greater than or equal to about 6.0 nm, greater than or equal to about 6.5 nm, greater than or equal to about 7.0 nm, greater than or equal to about 7.5 nm, greater than or equal to about 8.0 nm, greater than or equal to about 8.5 nm, greater than or equal to about 9.0 nm, greater than or equal to about 9.5 nm, greater than or equal to about 10 nm, or any range or value therein between.

In some embodiments, the catalyst deposits have an average diameter of less than or equal to about 10 nm, less than or equal to about 9.5 nm, less than or equal to about 9.0 nm, less than or equal to about 8.5 nm, less than or equal to about 8.0 nm, less than or equal to about 7.5 nm, less than or equal to about 7.0 nm, less than or equal to about 6.5 nm, less than or equal to about 6.0 nm, less than or equal to about 5.5 nm, less than or equal to about 5.0 nm, less than or equal to about 4.5 nm, less than or equal to about 4.0 nm, less than or equal to about 3.5 nm, less than or equal to about 3.0 nm, less than or equal to about 2.9 nm, less than or equal to about 2.8 nm, less than or equal to about 2.7 nm, less than or equal to about 2.6 nm, less than or equal to about 2.5 nm, less than or equal to about 2.4 nm, less than or equal to about 2.3 nm, less than or equal to about 2.2 nm, less than or equal to about 2.1 nm, less than or equal to about 2.0 nm, or any range or value therein between.

### Ionomer

In some embodiments, supported catalyst systems according to the present disclosure comprise bimodal porous supports comprising porous bodies having interconnected pores (primary pores) throughout their 3D structures and ionomers introduced into the secondary pores defined by the spaces between the porous bodies and interconnecting structures.

The ionomers may comprise any suitable material for conducting electrons and facilitating a catalyzed reaction (e.g., ORR). In some embodiments, the ionomer comprises a cation-conducting polymer or an anion-conducting polymer. In some embodiments, the ionomer comprises a bis[(perfluoroalkyl)sulfonyl] imide-based ionomer, polystyrene sulfonate, acrylic resin (e.g., HYCAR®), acrylic acid—ethylene copolymers or methacrylic acid—ethylene copolymers (e.g., SURLYN™), or polyaromatic ionomers. In some embodiments, the ionomer comprises a tetrafluoroethylene-based fluoropolymer (e.g., NAFION™).

### Methods of Making Supported Catalyst Systems, MEAs, and Fuel Cells

In another aspect, which may be combined with any other aspect or embodiment, the present disclosure relates to a method of making a supported catalyst system, the method comprising: providing a bimodal porous support, the support comprising: a plurality of porous bodies connected by interconnecting structures, wherein the porous bodies have primary pores throughout their structures, the primary pores defined by a first average pore diameter; and wherein the spaces between the interconnected porous bodies define secondary pores having a second average pore diameter; and depositing catalyst deposits within the primary pores. In some embodiments, the catalyst deposits are deposited in the primary pores by atomic layer deposition. In some embodiments, the method further comprises introducing an ionomer into the secondary pores. In some embodiments, the ionomer contacts the outer surfaces of the porous bodies and the interconnecting structures but does not contact the inner surfaces of the primary pores or the catalyst deposits therein.

In another aspect, which may be combined with any other aspect or embodiment, the present disclosure relates to a membrane electrode assembly (MEA), comprising: a gas diffusion layer; a polymer electrolyte membrane; and the supported catalyst system according to any of the embodiments disclosed herein, wherein the supported catalyst system is between the gas diffusion layer and the polymer electrolyte membrane. Such MEAs may be produced by contacting a gas diffusion layer with a first side of a supported catalyst system according to the present disclosure; and contacting a polymer electrolyte membrane with a second side of the supported catalyst system, such that the supported catalyst system is between the polymer electrolyte membrane and the gas diffusion layer.

In another aspect, which may be combined with any other aspect or embodiment, the present disclosure relates to a fuel cell, comprising a membrane electrode assembly, the membrane electrode assembly comprising: a gas diffusion layer; a polymer electrolyte membrane; and the supported catalyst system according to any of the embodiments disclosed herein, wherein the supported catalyst system is between the gas diffusion layer and the polymer electrolyte membrane.

In some embodiments, an MEA comprising a supported catalyst system according to the present disclosure has an average mass-normalized ORR activity (MA) of greater than or equal to about 0.44 A/mg_{Pt} at 0.9 V. In some embodiments, an MEA comprising a supported catalyst system according to the present disclosure has an average mass-normalized ORR activity (MA) of greater than or equal to about 0.5 A/mg_{Pt} at 0.9 V, greater than or equal to about 0.55 A/mg_{Pt} at 0.9 V, greater than or equal to about 0.60 A/mg_{Pt} at 0.9 V, greater than or equal to about 0.65 A/mg_{Pt} at 0.9 V, greater than or equal to about 0.70 A/mg_{Pt} at 0.9 V, greater than or equal to about 0.75 A/mg_{Pt} at 0.9 V, greater than or equal to about 0.80 A/mg_{Pt} at 0.9 V, greater than or equal to about 0.85 A/mg_{Pt} at 0.9 V, greater than or equal to about 0.90 A/mg_{Pt} at 0.9 V, greater than or equal to about 0.95 A/mg_{Pt} at 0.9 V, greater than or equal to about 1.0 A/mg_{Pt} at 0.9 V, greater than or equal to about 1.1 A/mg_{Pt} at 0.9 V, greater than or equal to about 1.2 A/mg_{Pt} at 0.9 V, greater than or equal to about 1.3 A/mg_{Pt} at 0.9 V, greater than or equal to about 1.4 A/mg_{Pt} at 0.9 V, greater than or equal to about 1.5 A/mg_{Pt} at 0.9 V, or any range or value therein between.

In some embodiments, an MEA comprising a supported catalyst system according to the present disclosure has a specific activity (SA) of greater than or equal to about 0.25 mA/cm²_{Pt} at 0.9 V, greater than or equal to about 0.27 mA/cm²_{Pt} at 0.9 V, greater than or equal to about 0.30 mA/cm²_{Pt} at 0.9 V, greater than or equal to about 0.32 mA/cm²_{Pt} at 0.9 V, greater than or equal to about 0.34 mA/cm²_{Pt} at 0.9 V, greater than or equal to about 0.35 mA/cm²_{Pt} at 0.9 V, greater than or equal to about 0.36 mA/cm²_{Pt} at 0.9 V, greater than or equal to about 0.38 mA/cm²_{Pt} at 0.9 V, greater than or equal to about 0.40 mA/cm²_{Pt} at 0.9 V, greater than or equal to about 0.42 mA/cm²_{Pt} at 0.9 V, greater than or equal to about 0.44 mA/cm²_{Pt} at 0.9 V, greater than or equal to about 0.45 mA/cm²_{Pt} at 0.9 V, greater than or equal to about 0.46 mA/cm²_{Pt} at 0.9 V, greater than or equal to about 0.47 mA/cm²_{Pt} at 0.9 V, greater than or equal to about 0.48 mA/cm²_{Pt} at 0.9 V, greater than or equal to about 0.49 mA/cm²_{Pt} at 0.9 V, greater than or equal to about 0.50 mA/cm²_{Pt} at 0.9 V, greater than or equal to about 0.51 mA/cm²_{Pt} at 0.9 V, greater than or equal to about 0.52 mA/cm²_{Pt} at 0.9 V, greater than or equal to about 0.53 mA/cm²_{Pt} at 0.9 V, greater than or equal to about 0.54 mA/cm²_{Pt} at 0.9 V, greater than or equal to about 0.55 mA/cm²_{Pt} at 0.9 V, greater than or equal to about 0.56 mA/cm²_{Pt} at 0.9 V, greater than or equal to about 0.57 mA/cm²_{Pt} at 0.9 V, greater than or equal to about 0.58 mA/cm²_{Pt} at 0.9 V, greater than or equal to about 0.59 mA/cm²_{Pt} at 0.9 V, greater than or equal to about 0.60 mA/cm²_{Pt} at 0.9 V, or any range or value therein between.

While the foregoing terms are believed to be well understood by one of ordinary skill in the art, the following definitions are set forth to facilitate explanation of the presently disclosed subject matter.

The term “a” or “an” may refer to one or more of that entity, i.e. can refer to plural referents. As such, the terms “a” or “an”, “one or more” and “at least one” are used interchangeably herein. In addition, reference to “an element” by the indefinite article “a” or “an” does not exclude the possibility that more than one of the elements is present, unless the context clearly requires that there is one and only one of the elements.

Reference throughout this specification to “one embodiment”, “an embodiment”, “one aspect”, or “an aspect” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

As used herein, the terms “about” or “approximately” when preceding a numerical value indicates the value plus or minus a range of 10% of the value.

As used herein, the term “NCSy” means a “nanoporous carbon support” with an average primary pore diameter of y nm. As used herein, the term “Ptx,” when used in conjunction with a nanoporous carbon support, means Pt nanoparticles deposited using x ALD cycles. For instance, “Pt10” means Pt nanoparticles deposited using 10 ALD cycles. Thus, the term “Ptx/NCSy” denotes a nanoporous carbon support (NCS) having an average primary pore diameter of y nm with Pt nanoparticles in the primary pores, the Pt nanoparticles deposited using x ALD cycles. For instance, “Pt10/NCS12” denotes a nanoporous carbon support (NCS) having an average primary pore diameter of 12 nm with Pt nanoparticles in the primary pores, the Pt nanoparticles deposited using 10 ALD cycles.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. While not explicitly defined below, such terms should be interpreted according to their common meaning.

In addition, where features or aspects of the disclosure are described in terms of Markush groups, those skilled in the art will recognize that the disclosure is also thereby described in terms of any individual member or subgroup of members of the Markush group.

Unless the context indicates otherwise, it is specifically intended that the various features of the invention described herein can be used in any combination. Moreover, the disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless explicitly indicated otherwise, all specified embodiments, features, and terms intend to include both the recited embodiment, feature, or term and equivalents thereof.

All patents, patent applications, provisional applications, and publications referred to or cited herein are incorporated by reference in their entirety, including all figures and tables, to the extent they are not inconsistent with the explicit teachings of this specification.

Reference will now be made in detail to some specific embodiments contemplated by the present disclosure. While various embodiments are described herein, it will be understood that it is not intended to limit the present technology to the described embodiments. On the contrary, it is intended to cover alternatives, modifications, and equivalents as may be included within the spirit and scope of the technology as defined by the appended claims.

### EXAMPLES

World-wide efforts are increasingly being focused on reducing the world's reliance on fossil fuels while moving towards the implementation of renewable energy. However, due to the intermittency problem inherent with renewable energy, this transition is challenged by the need for energy storage options. These include electrochemical technologies, such as rechargeable batteries and capacitors, as well as energy storage in the form of chemicals and fuels, e.g., green hydrogen, produced in electrolysis cells and then fed to a fuel cell, along with air, to efficiently generate clean electricity. Massive research efforts are underway to improve the activity and durability of these devices by developing new electrodes and electrocatalysts, as well as re-engineering their morphologies at the nanoscale. However, making a step-change forward is difficult due to the uncertainty and variability in the distribution of each component and their local environments.

Among other things, the present embodiments address this issue and others specifically for proton exchange membrane fuel cell (PEMFC) cathodes by creating an ordered carbon nanostructure that allows the micro-environments to be characterized and at least partly controlled. PEMFCs have many advantages, including their high power densities, fast start-up [1], clean products (water), and ultra-rapid refueling (recharge), making them ideal for transportation applications [2,3]. PEMFCs currently still rely on Pt to catalyze both hydrogen oxidation and the oxygen reduction reaction (ORR), typically in nanoparticle (NP) form in order to maximize the surface to area ratio and thus significantly lower cost. While non-precious metal catalysts and alloys of Pt [4,5] are also under development, PEMFC commercialization efforts, e.g., the Toyota Marai [6] still rely on Pt catalysts, as they provide the best combination of activity and stability, especially for the sluggish ORR [7,8], the reaction that is the target of the majority of current electrocatalysis research.

In a PEMFC, the catalyst layers are normally constructed from inks containing carbon powder-supported Pt NPs mixed with a perfluorosulfonic acid proton-conducting ionomer, such as NAFION™. In an ideal ORR catalyst layer, the carbon particles should be fully interconnected for unimpeded electronic conduction, while the ionomer should be present as a continuous phase on or very close to the Pt NPs to facilitate the conduction of protons to the Pt surface [9].

Furthermore, fully inter-connected pores must also be present throughout these layers to serve as conduits for gas transport [10]. This highly complex 3-dimensional structure is key to achieving increasingly stringent PEMFC performance and durability metrics, with the majority of the critical parameters defined by the microstructure and surface properties of the carbon support. While the ionomer is considered essential to providing protons, recent studies have suggested that the sulfonate group terminating the NAFION™ side chains can specifically adsorb and even poison Pt surfaces, especially at the positive potentials of the cathode, causing a significant decrease (by 2-4 times) in the already slow ORR kinetics [11-14]. Also, the thin NAFION™ film that typically coats the Pt NPs leads to a gas-ionomer interface resistance for mass transport of oxygen. [15] The NAFION™-to-carbon ratio must therefore be optimized to balance the essential proton conductivity with the undesirable oxygen mass transport resistance and catalyst poisoning effects, depending on the type of ionomer, catalyst, and carbon support employed. This unavoidably leads to performance comprises.

Efforts to overcome the challenges associated with deleterious Pt/NAFION™ interactions in PEFC cathodes have included the development of ionomer-free electrodes, such as the nanostructured thin films pioneered by 3M [16], in which proton transport occurs along the surface of an inter-connected Pt thin film with assistance from water vapor, without the need for any ionomer [17]. However, these Pt thin films usually have a low electrochemical surface area (ECSA, 10-20 m²/gPt), causing significant voltage losses at high current densities [5]. Another strategy for minimizing the negative effects of NAFION™ on Pt catalysts has been to modify the pore size, inter-particle tortuosity, and wettability of the carbon powder support itself. As an example, Yarlagadda and coworkers [18] found that mesoporous carbons (containing short pores with a 4-7 nm diameter) and having a high surface area and pore volume can boost the Pt mass activity for the ORR to 0.36 A/mg Pt by housing the Pt NPs inside the mesopores. The effect of the carbon support in determining the catalyst-ionomer interactions and therefore catalytic activity has also been studied in systematic work by Kabir et al. [19] and also the present Applicant [20].

As the host for both the Pt catalyst and ionomer components, the carbon support clearly plays a critical role in establishing the specific environment for the catalyst and ionomer and thus influencing the interactions between them. However, traditional carbon supports generally contain only a single environment for housing both the catalyst and ionomer, with the carbon particle size, pore size, and surface wettability heavily influencing where the Pt NPs and ionomer ultimately reside. Here, embodiments provide a revolutionary catalyst layer microstructure, namely an organized bimodal carbon membrane in which the Pt catalyst is located in an environment free from ionomer poisoning but embedded within a catalyst layer that still contains ionomer. This seemingly self-contradictory objective has been achieved by the construction of a nanoporous ‘ball and stick’ carbon scaffold (NCS), consisting of primary [12] nm pores that house only the Pt NPs and a set of larger secondary pores where the ionomer resides. This novel bimodal structure therefore enables the characterization of the various catalyst-ionomer-carbon environments within the same electrode, especially considering that the internal NCS12 structure is completely uniform in three dimensions. It also provides an unprecedented avenue for investigating the ionomer-free catalytic activity of Pt NPs towards the ORR in a membrane electrode assembly (MEA), shown here to exhibit among the best ORR activity and durability reported as yet.

### Example 1. Materials and Methods

### Nanoporous Carbon Support Synthesis

The synthesis of the NCS films was outlined in detail in previous work. [23,41,47,48] In particular, NCS films with a nominal pore size of 12 nm and a bimodal porous structure were prepared using the same procedure reported for NCS membranes prepared with a monodisperse pore size, such as 85 nm (e.g., NCS85). [23] Briefly, 0.1 g of mesophase pitch (MP, Momentum Materials Corp.), 0.2 g of n-butanol, and 5.0 g of 10% polyvinyl alcohol (PVA, Alfa Aesar, 86-89% hydrolyzed) were ball-milled together, making a uniform MP/PVA ink. Then, a colloidal silica suspension containing 0.5 g silica (Ludox HS-40, average particle size of 12 nm) was added to 1.0 g of a 1,3-propanediol (PD):water mixture (mass ratio 1:1) to produce a silica suspension. Next, the silica suspension was added to the MP/PVA ink and was ball-milled to obtain the MP/PVA/PD/silica ink (or slurry), which was then degassed for 15 min to remove any bubbles.

The slurry was then tape-casted onto glass with a 0.010-inch gap between the doctor blade and the substrate. After drying overnight, a pristine composite MP/PVA/PD/silica film was obtained. These films were imprinted in an alumina tubular furnace at 400° C. for two hours in nitrogen, then heated at 900° C. for two hours in nitrogen to achieve carbonization. Finally, the carbonized films were brought to room temperature and soaked in 3 M NaOH at 80° C. for two days to remove the silica template, followed by successive washing with 1 M HCl, deionized water, and then drying at 80° C. overnight.

### Pt/NCS Preparation Via Atomic Layer Deposition (ALD)

Trimethyl(methylcyclopentadienyl) platinum (IV) (MeCpPtMe₃, Strem Chemicals) was used as the Pt ALD precursor, with air used as the oxidant. Pt ALD was conducted at a reactor temperature of 190° C., and the Pt precursor was heated at 78° C. The exposure time for both the Pt precursor and air was optimized, being 9 s and 5 s, respectively. Argon was used as the inert gas to remove any unreacted precursor. The inert gas purge time after Pt precursor exposure was 100 s, and the purge time after air exposure was 50 s.

### Material Characterization

Nitrogen gas sorption analysis was performed using a 3Flex Version 3.01 analyzer (Alberta Sulfur Research Ltd). The specific surface area and porosity of the NCS samples were measured at 77 K after a prior degassing at 150° C. for 4 hours. Advanced temperature-programmed desorption (TPD) was performed using an in-house high vacuum apparatus [49]. Samples were heated to ultra-high temperatures of 1800° C. to fully decompose the oxygen-functional groups on the NCS12 surface and to convert the H-terminated edge sites to H₂O, CO, CO₂, and H₂ gases. The quantification of the evolved gases thus enabled the precise bulk analysis of the H and O contents in the samples.

X-ray photoelectron spectroscopy was performed using a PHI VersaProbe 1 with Al(Kα) radiation of 1486 eV. Field emission scanning electron microscopy (FESEM) analysis was carried out using a Zeiss Sigma VP at an accelerating voltage of 8 kV. Separately, spatial maps for platinum were collected via energy dispersive X-ray spectroscopy (EDS) on an FEI Quanta 250 FEG with a Bruker Quantax attachment.

Scanning/transmission electron microscopy (S/TEM) imaging was performed on a JEOL JEM ARM200cFS/TEM instrument, equipped with a cold Field-Emission Gun (cFEG) and a probe Cs corrector, at an accelerating voltage of 200 kV. The STEM images (HAADF, BF and BEI modes) with EDX mapping were collected using the following experimental conditions: probe size 4c, condenser lens aperture 30 μm, scan speed 40 μs per pixel, and camera length 8 cm. Samples were examined either as drop-casted ethanol-based suspensions of NCS powder on Cu grids or as 100 nm microtomed cross-sectional slices of the Pt/NCS12 films and MEA catalyst layers.

Cyclic voltammetry in aqueous solutions was carried out with a Bio-Logic SP-300 potentiostat using a 3-electrode cell containing deaerated 0.5 M H2SO4, a platinized Pt mesh as the counter electrode, and a reversible hydrogen (RHE) reference electrode. Generally, a piece of the NCS12 or Pt/NCS12 film (ca. 1 cm²) was sandwiched between two pieces of carbon paper, where a small circular hole was cut into one of them to expose a 0.8 cm² area of the film to the solution to serve as the working electrode. The Wilhelmy plate method was used to measure the water contact angle of NCS under ambient conditions (25° C. and 0.1 MPa)45. DI water was gradually added onto 1×2 cm2 pieces of NCS in a Petri dish, while a Canon EOS Rebel SL2 camera recorded the droplet shapes at 25 frames per second. Equilibrium contact angles were then measured using ImageJ.

### MEA Construction and Testing

After ALD of platinum, the Pt loading of the Ptx/NCS12 and Pt10/NCS85 films was measured using x-ray fluorescence (XRF) using an AMETEK Spectro Xepos HE. For single cell tests, each film was then placed on a carbon paper gas diffusion layer (Freudenberg H23C8, Fuel Cell Store) onto which a 4 wt % isopropanol-based solution of NAFION™ D2021 was drop casted and left to air-dry. The ionomer:carbon ratio was estimated to be ˜4, based on the volume of the NAFION™ solution D2021 added to the isopropyl alcohol. However, this ratio is just an estimate, as during drop-casting, some of the ionomer solution went into the MPL/GDL. After air drying, the cathode GDE was hot pressed onto a commercial anode-coated membrane ((ACM), where the membrane thickness was 18 μm, the anode catalyst layer thickness was about 5 μm, and the Pt/C anode had a Pt loading of 0.1 mgPt/cm2), all at 120° C. and at 500 lb-f/cm². The counter electrode active area was kept constant during all MEA measurements at 5 cm², while the working electrode area was 1.6±0.4 cm².

The resulting gas diffusion electrode (GDE) was then assembled with a commercial anode-coated membrane (ACM) (18 μm thick, anode Pt loading of 0.1 mgPt/cm²) and hot pressed at 120° C. and 500 lbf/cm². These membrane electrode assemblies (MEA) were then assembled with Freudenberg H23C8 gas diffusion layers and compressed to 4 bar between graphite serpentine flow fields (50 cm² total active area and 40 channels with ca. 0.4 mm wide land/channels) in a Greenlight test fixture.

MEA testing was performed using a Scribner 840 fuel cell test station supplied with ultrahigh purity H₂, O₂ and Ar gases (Praxair). H₂-air and H₂—O₂ measurements were made at 80° C., 100% RH and 150 kPa_{abs}, with cathode and anode gas flow rates of 5000 and 500 sccm, respectively. Specific details about the conditioning and measurement protocols used here were identical to those reported in previous publications. [23,50] To establish a baseline comparison for the performance of NCS-based cathodes, a commercial catalyst-coated membrane (anode and cathode loadings of 0.1 and 0.4 mgPt/cm², respectively) was also evaluated under identical test conditions. To evaluate the Pt accessibility and proton transport properties of the Pt/NCS cathodes, cyclic voltammograms were collected at various relative humidities (i.e., 30%, 50% and 80% RH). Accelerated durability tests (ADT) were performed using 10,000 square-wave potential cycles between 0.6 V and 0.95 V, with 3-second holds at each potential. These ADTs were performed under H2-Ar at 80° C., 100% RH and 150 kPa_{abs}, with cathode and anode gas flow rates of 1000 and 1000 sccm, respectively.

### Example 2. Structural Characterization of Bimodal Nanoporous Carbon Supports

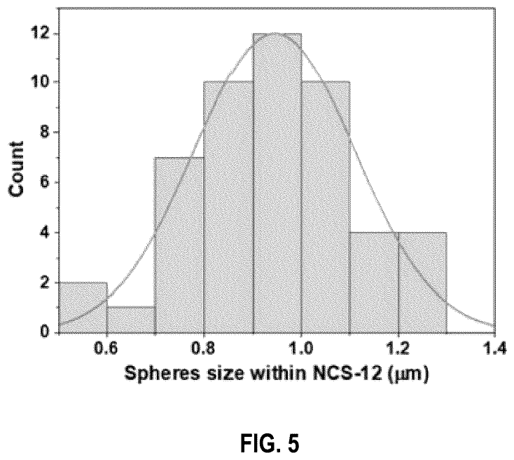

As shown in FIG. 1A-1E, nanoporous carbon supports (“NCSs”) prepared according to the present disclosure exhibit a well-defined bimodal structure of the NCS12 backbone. FIGS. 1A-1E illustrate the organized, bimodal (‘ball-and-stick’) microstructure of the NCS12 membrane (NCS with 12-nm primary pores), with each ball (sphere) composed of a uniformly porous structure of 3-D interconnected and ordered 12 nm pores. Each carbon sphere is tethered to its neighbors by carbon fibers (sometimes referred to herein as “sticks”), producing a physically robust membrane, with the larger secondary pores between the spheres giving the NCS12 its bimodal pore structure (FIG. 1A). As shown in FIG. 5, the spheres are uniform in size (diameter=0.95±0.17 μm), with the connecting fibers being non-porous and roughly 20 nm in diameter, producing a structure reminiscent of the Craspedia flower (see FIG. 1B). Overall, ˜90% of the internal volume of the NCS12 membrane consists of the 12 nm primary pore environment found within the spheres, while the remaining volume consists of the larger secondary pores (up to ˜250 nm in diameter) between the spheres.

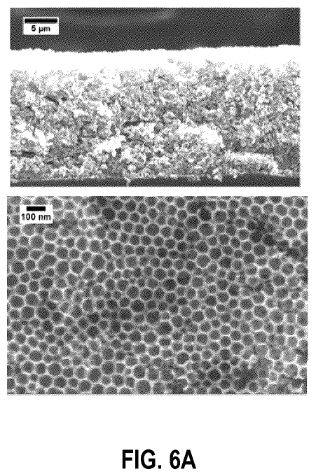

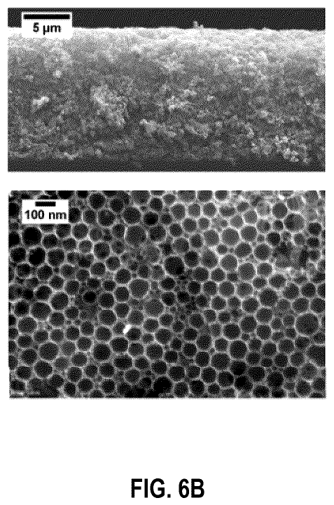

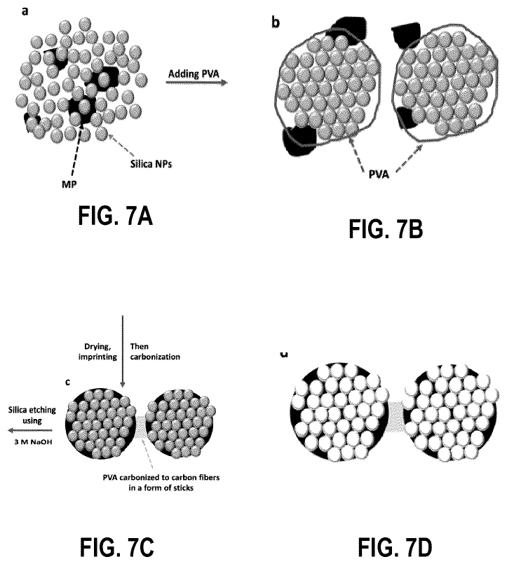

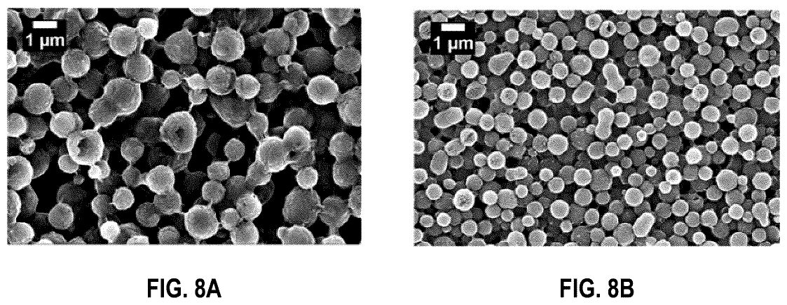

This morphology is very different from that of analogous colloid imprinted carbon (CIC) powders with 12-15 nm pore sizes [21,22] and the monodisperse porosity in previously reported NCS85 and NCS50 membranes [23], which are shown in FIG. 6A-B. Referring to FIGS. 7A-D, the ball-and-stick nanostructure of the NCS12 membrane stems from use of polyvinyl alcohol (PVA) to accelerate and catalyze agglomeration of 12 nm colloidal silica particles into spheres that are ˜1 μm in diameter. During imprinting at 400° C., mesophase pitch penetrates the spheres, leaving the voids between them empty. The PVA concentration plays an important role in controlling the properties of the nano-sticks. FIG. 1C shows a cross-sectional view of an 18 μm thick NCS12 membrane, revealing excellent thickness uniformity and that the same features are retained throughout the film in 3-D. Notably, the internal dimensions of the components within the NCS12 can be tuned by variations in the preparation conditions (see FIG. 8A-B).

### Example 3. BET-Determined Surface Area of Bimodal Nanoporous Carbon Supports

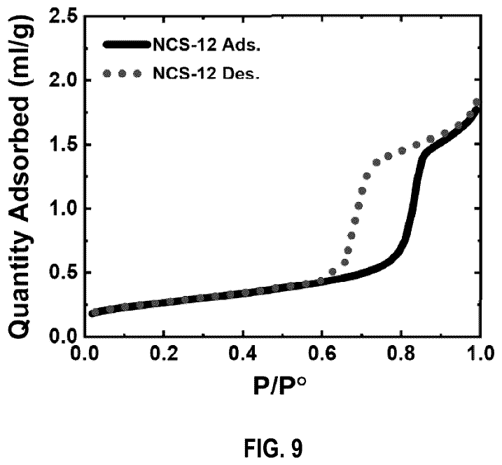

Referring to Tables 1-2, the BET-determined surface area of the NCS12 membrane is ˜610 m²/g, with the external and microporous surface areas being ˜545 and ˜65 m²/g, respectively. Referring to FIG. 9, nitrogen sorption analysis reveals a Type IV isotherm, where the observed hysteresis is due to capillary condensation within the 12 nm mesopores, while also indicating the presence of smaller pore necks within the sphere. [24] Using the Barrett-Joyner-Halenda (BJH) method, the pore size distribution of NCS12 was obtained from the adsorption branch (see, e.g., FIG. 1D), with the narrow peak at 11.5-12 nm confirming the excellent microstructural uniformity. The BJH method demonstrated an average pore neck diameter of 5.7 nm, with 12 necks present per mesopore within the spheres (see FIG. 1E). As shown in Table 2, roughly 98% of the BET surface area originates from the 12 nm pores in the spheres, while the outer surface of the spheres plus the sticks contribute the remaining ˜2%.

TABLE 1
Structural Properties of Ball-and-Stick Structured NCS12
Compared to Monodisperse Porous Structure of NCS85. [14]

| | Pore | Neck | | | | | | | |
|---|---|---|---|---|---|---|---|---|---|
| | Diam. | Diam. | S_{BET} | Sₑₓₜₑᵣₙₐₗ | S_{micro} | S_{micro}/S_{BET} | V_{NSI} | V_{NSI} | V_{micro}/V_{NSI} |
| Sample | (nm)^{a} | (nm)^{b} | (m²/g)^{c} | (m²/g)^{d} | (m²/g)^{e} | (%) | (ml/g)^{f} | (ml/g)^{d} | (%) |
| NCS12 | 11.7 | 5.7 | 611 | 545 | 66 | 10.8 | 2.0 | 0.030 | 1.50 |
| NCS85 | 82 ± 12 | 16 ± 1 | 194 ± 5 | 62 ± 1.4 | 32 ± 3.4 | 16.2 | 1.2 ± 0.1 | 0.016 | 1.32 |
| [14, 15] | | | | | | | | | |

^{a}Pore size obtained from the maximum in the pore size distribution plots (adsorption branch), FIG. 1C, for NCS12.
^{b}Pore neck width obtained from the maximum in the pore size distribution plots (desorption branch), FIG. 1D, for NCS12.
^{c}S_{BET} = total surface area, obtained using the Brunauer-Emmett-Teller (BET) plot in the partial pressure range of 0.05 < P/Pₒ < 0.30.
^{d}Sₑₓₜₑᵣₙₐₗ = external surface area and V_{micro} = micropore volume, both obtained using the t-plot method in the partial pressure range of 0.2 < P/Pₒ < 0.5, with carbon black used as the reference.
^{e}S_{micro} = micropore surface area, obtained by subtracting the external surface area (Sₑₓₜₑᵣₙₐₗ) from the total surface area (S_{BET}).
^{f}V_{NSI} = pore volume, acquired from N₂ adsorption isotherms at P/Pₒ = 0.98.

TABLE 2
Contribution of Outer and Inner Surface Area of
Porous Bodies to Total Surface Area of NCS 12.

| Parameter | Equation | Value | Units |
|---|---|---|---|
| Average sphere diameter (d) | d | 9.5 × 10² | nm |
| Average sphere volume (V) | 0.52 × d³ | 4.5 × 10⁸ | nm³ |
| Average sphere surface area (A) | 3.14 × d² | 2.8 × 10⁶ | nm² |
| Pore diameter (h) | H | 12 | nm |
| Average volume of nanopore (v) | 0.52 × h³ | 9.0 × 10² | nm³ |
| Average Number of Pores Per Sphere | V × (0.75/v) | 3.7 × 10⁵ | |
| (N) | | | |
| Average Surface Area of Nanopore | 3.14 × N × | 1.7 × 10⁸ | nm² |
| (a) | h² | | |
| Contribution of Outer Sphere Area to | A/(a − A) × | 1.7 | % |
| Total Surface Area | 100 | | |
| Contribution of Inner Sphere Area to | 100-1.7 | 98.3 | % |
| Total Surface Area | | | |

### Example 4. ALD of Pt in Primary Pores and Introduction of NAFION™ into Secondary Pores of Bimodal Nanoporous Carbon Support

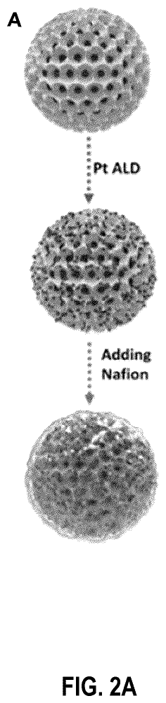

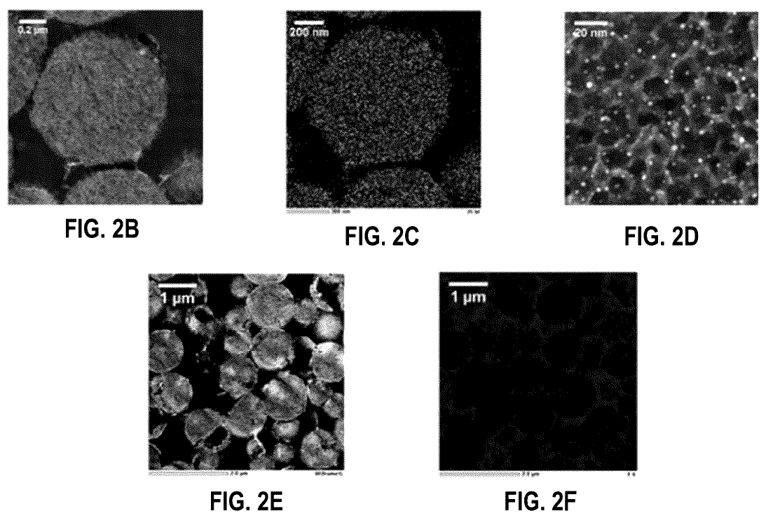

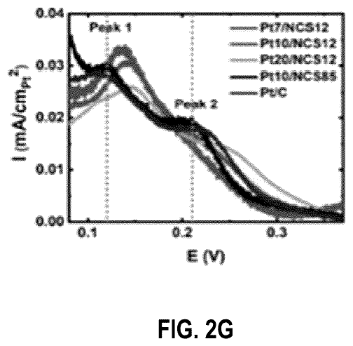

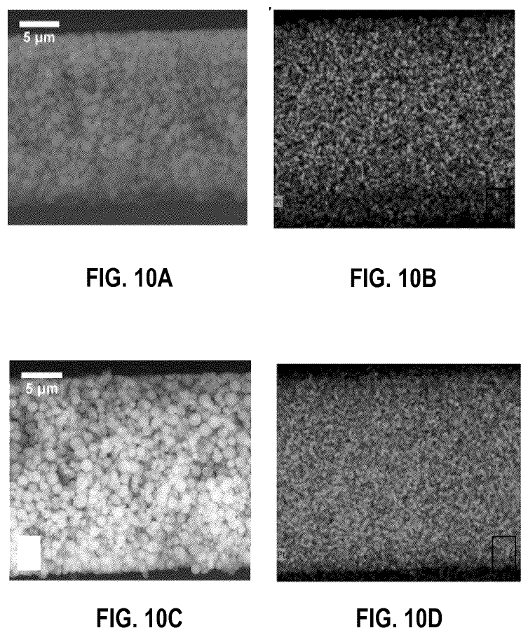

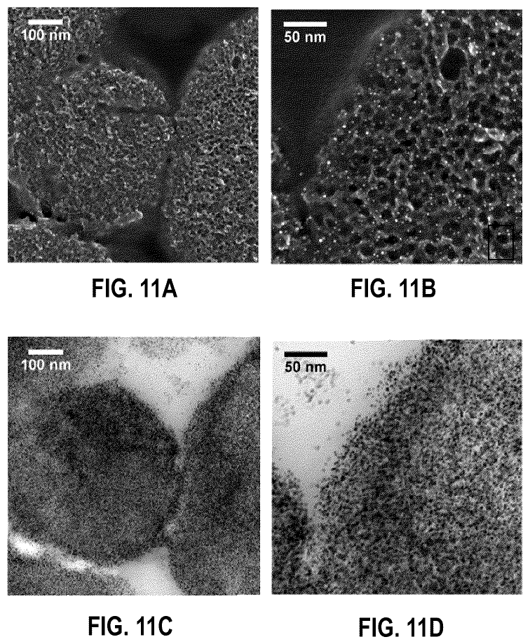

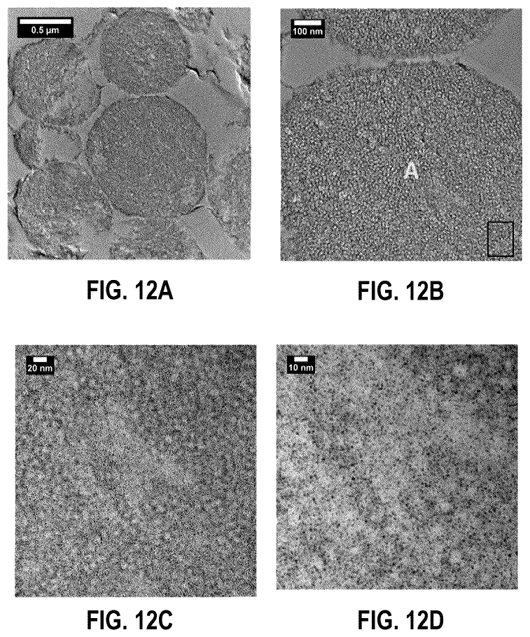

FIG. 2A shows a simple schematic illustration of the fabrication steps used in the Pt and NAFION™ loading of NCS12 membranes prepared according to the present disclosure, starting with x=7-20 cycles of Pt atomic layer deposition (ALD) and ending with the wet-impregnation of NAFION™. ALD is ideal for loading small and uniformly-dispersed Pt NPs throughout free-standing NCS membranes that have monodisperse pore sizes [23]. Their highly ordered and open porosity provides exceptional line-of-sight when compared to conventional carbon powders. The ALD-Pt precursor (methylcyclopentadienyl trimethyl-platinum (MeCpPt-Me3)) is ˜1 nm in its longest dimension, significantly smaller than the 12 nm pores and ˜6 nm necks within the NCS12 spheres, allowing vapor-phase precursor to access all of the internal surfaces. Referring to FIG. 2B and FIG. 2C, EDX mapping of Pt within individual spheres and across the full thickness of a NCS membrane prepared using 10 ALD cycles membrane (see FIG. 10C and FIG. 10D) confirms that this is indeed the case.

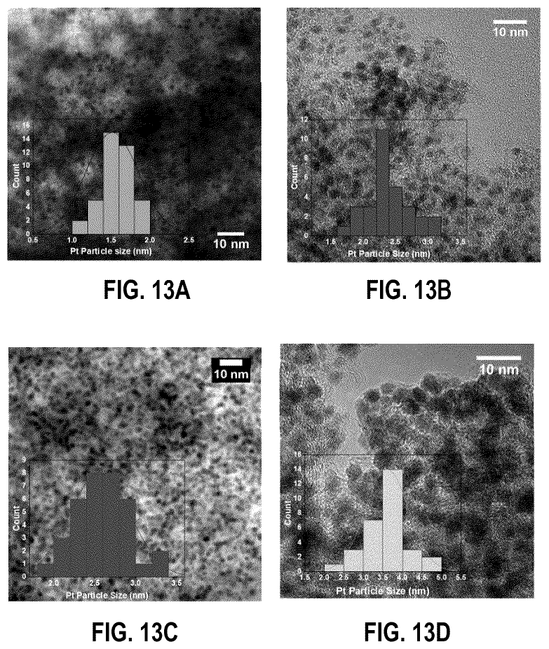

Higher magnification scanning transmission electron microscopy (STEM) analysis (FIG. 2D and FIGS. 11A-D) and TEM imaging (FIGS. 12A-D) both reveal that the 12 nm pores within the spheres are uniformly decorated with highly dispersed Pt NPs after 7-10 ALD cycles. Pt NPs were observed on the outer surfaces of the spheres only when 20+ ALD cycles were applied. These results show that the location of the Pt NPs can be controlled within the NCS12 membranes by the number of atomic layer deposition steps employed. Referring to FIGS. 13A-D, high-resolution TEM shows that the Pt NP sizes within the spheres are 1.5±0.3 nm, 2.4±0.4 nm, and 3.6±0.6 nm after applying 7, 10, and 20 ALD-Pt cycles, respectively, with consistently narrow particle size distributions.

After NAFION™ loading, STEM imaging and EDX mapping for fluorine (FIG. 2E and FIG. 2F) on cross-sections show that the ionomer is very well distributed throughout the NCS12 sheet, but that it resides only in the large (up to ˜250 nm) secondary pores between the spheres while also surrounding the connecting carbon fibers, providing an inter-connected pathway for proton transport across the entire membrane under PEFC operation. In contrast, no fluorine is observed inside the spheres, the region where the vast majority of the Pt NPs reside. Referring to Table 3, NAFION™ cannot penetrate pores <20 nm in size and is therefore incapable of accessing the 12 nm pores within the NCS12 spheres [23, 25]. The result is a porous carbon membrane containing both catalytic Pt NPs and NAFION™ in precise locations, but fully separated from each other. This configuration allowed unprecedented observation of electrochemistry of Pt NPs in a MEA without interference from NAFION™, which may permit observation of any Pt poisoning effects.

TABLE 3
Summary of Electrochemical Properties of ALD-Pt/NCS Films

| | | | | | ECSA | | |
|---|---|---|---|---|---|---|---|
| | | Particle | Exptl. | Pt | HUPD in | | |
| | Loading | Size | ECSA | ECSA | 0.5M H₂SO₄ | Utilization | Utilization |
| Sample | (mg/cm²)^{a} | (nm)^{b} | (m²/g_{Pt})^{c} | (m²/g_{Pt})^{d} | (m²/g_{Pt}) | (%)^{e} | (%)^{f} |
| Pt7/NCS12 | 0.12 | 1.5 ± 0.3 | 100 ± 20 | 187 ± 31 | 91 | 80 | 100 |
| Pt10/NCS12 | 0.22 | 2.4 ± 0.4 | 127 ± 15 | 117 ± 17 | 141 | 100 | 100 |
| Pt20/NCS12 | 0.965 | 3.6 ± 0.6 | 84 ± 8 | 78 ± 10 | 88 | 96 | 95 |
| Pt10/NCS85 | 0.1 | 2.2 ± 0.4 | 88 ± 9 | 127 ± 27 | — | 70 | — |

^{a}Estimated from X-ray fluorescence (XRF).
^{b}Determined from TEM images (FIGS. 12A-12D).
^{c}Experimental electrochemical surface area (ECSA) obtained from anodic HUPD charge.
^{d}Assumes all Pt NPs are spherical in shape; using the bulk Pt density (21.45 g/cm³).
^{e}Calculated by dividing the ECSA obtained from HUPD charge (c) by the surface area estimated from the Pt NP size obtained by TEM analysis (d), with adjustment in the error bars of the Pt NP sizes and experimental ECSA).
^{f}Utilization calculated by dividing the ECSA obtained from HUPD charges measured in the MEA by the ECSA obtained from HUPD charges measured in 0.5M H₂SO₄.

### Example 5. Electrochemical Performance of Bimodal NCSs in Membrane Electrode Assemblies

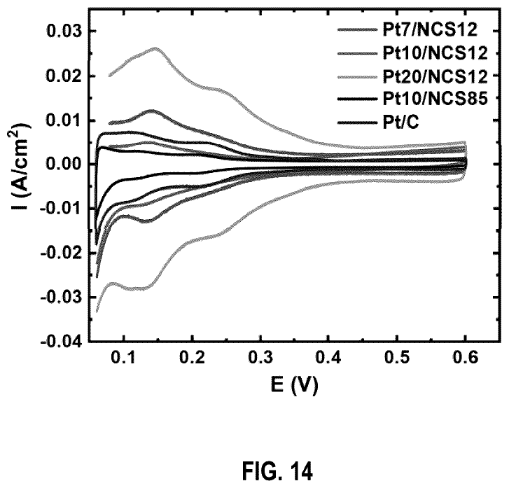

A Pt/NAFION™-loaded NCS12 membrane was loaded into a membrane-electrode-assembly (MEA) to serve as the cathode catalyst layer, using a conventional Pt/carbon anode layer. It was then evaluated by cyclic voltammetry in humidified argon to establish the electrochemically active surface area (ECSA) of the Pt NPs from the hydrogen underpotential adsorption/desorption (HUPD) peak charges (FIG. 14.), which are indicative of the true area of Pt available to receive/donate protons, typically via NAFION™. As shown in Table 4, this analysis showed exceptionally high ECSA values of 130 m²/g, compared to ˜75 m²/gPt in MEAs constructed from conventional Pt/carbon powders [26]. The Pt utilization (HUPD-determined ECSA vs. the theoretical ECSA, obtained from TEM particle size analysis (FIGS. 13A-D) is also exemplary, being very close to 100%. This is particularly noteworthy when considering that the Pt NPs are located far away from the ionomer (see FIG. 2C and FIG. 2F), indicating that protons must be supplied to the Pt NPs by some means other than NAFION™.

TABLE 4
HUPD Peak Potentials (Ep, V vs. Pt/H₂) from CVs for ALD-
Pt/NCS Catalyst Layer Tested in a MEA Configuration

| | NAFION ™/Pt in | | |
|---|---|---|---|
| Catalyst | close contact? | Ep (Peak 1)* | Ep (Peak 2)* |
| Commercial Pt/C powder | Yes | 0.11 | 0.22 |
| ALD Pt10/NCS85 | Yes | 0.12 | 0.21 |
| ALD Pt7/NCS12 | No | 0.135 | — |
| ALD Pt10/NCS12 | No | 0.14 | — |
| ALD Pt20/NCS12 | No | 0.15 | 0.245 |

*Peak potentials (Ep) were collected from CVs (e.g., FIG. 2G and FIG. 14) collected in MEAs at 20 mV/s, 100% RH Ar, and 80° C.

Referring to FIG. 14, there are distinct differences in the HUPD peak potentials for the ALD-Ptx/NAFION™/NCS12 samples compared to conventional Pt/carbon powders and ALD-Pt hosted on NCS85 membranes [16], catalysts in which the Pt NPs and the NAFION™ ionomer are co-located. For these latter two cases (FIG. 2G), oxidation peaks 1 and 2 are centered at 0.11-0.12 V and 0.21-0.22 V, respectively, typical of Pt NPs in most commercial MEAs [27,28]. Peak 1 has been ascribed to the HUPD process at Pt110 surfaces, while Peak 2 has been attributed to the deposition/removal of strongly adsorbed H at Pt100 and/or Pt111 surfaces [28-30]. However, the bimodal Pt7/NCS12 and Pt10/NCS12 membranes show only one H desorption peak at ˜0.14 V (see Table 4), while Pt20/NCS12 also shows a second peak at ˜0.25 V. The presence of anions that specifically adsorb onto Pt (e.g., chloride, sulfate and bisulfate [24])), results in a negative shift of the HUPD peaks on Pt, as the H atoms must compete with the anions for Pt surface sites [31-33]. The observed positive shift of the HUPD peaks in NCS12 relative to conventional Pt/C catalysts, where Pt and NAFION™ are in very close proximity, is consistent with the NAFION™-free micro-environment within the spheres, the region in which the Pt NPs are located (FIG. 2F).

### Example 6. Oxygen Reduction Activity in ALD-Pt/NAFION™/NCS12 Membrane-Electrode Assemblies

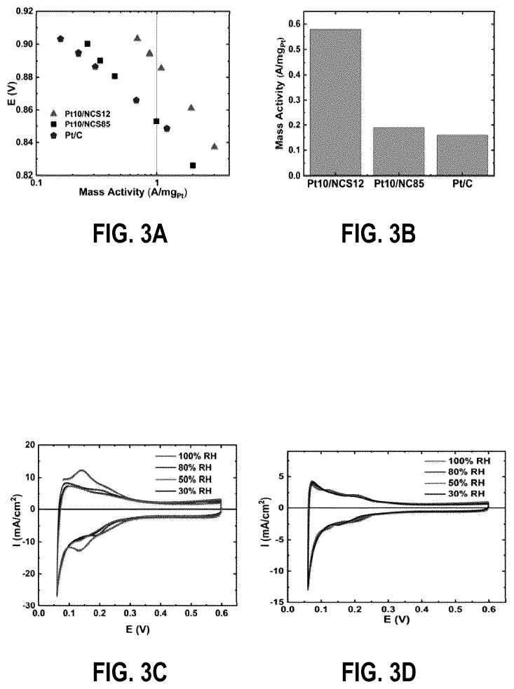

The ORR activity of the NCS12-based catalyst layers was evaluated in a H₂/O₂-fed MEA over a wide current range at 80° C. Compared to the best that can be delivered by state-of-the-art commercial Pt/C catalysts [26,34] and ALD-Pt10/NCS85 material, the present catalysts show an average mass-normalized ORR activity (MA) of 0.58 A/mg_{Pt} at 0.9 V, which is a 3-fold enhancement (FIGS. 3A-3B), while also giving ˜1.3 times the MA of the Department of Energy (DOE) 2025 targets (0.44 A/mg_{Pt}). This surprisingly high mass activity is the highest among recent studies on pure Pt catalysts (see Table 5). [26,34]

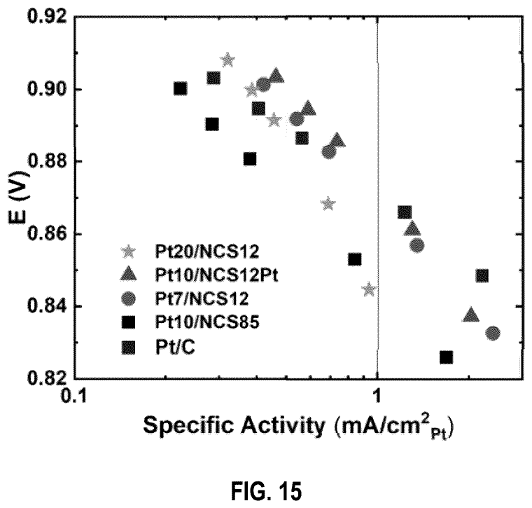

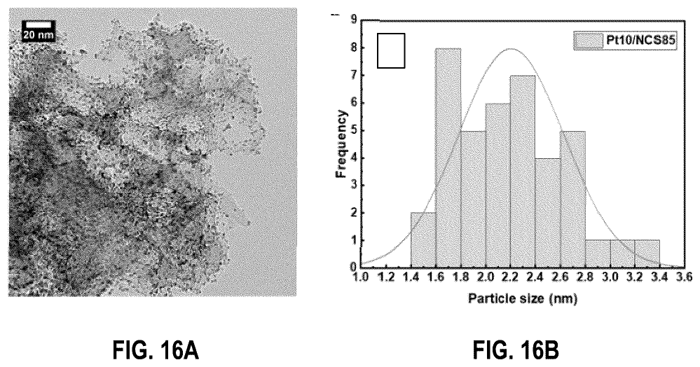

FIG. 15 shows the current density at 0.9 V normalized to the ECSA, giving the specific activity (SA) (i.e., the intrinsic catalytic activity of a Pt surface) (see Table 5). Despite having smaller NP sizes, the present Ptx/NCS12 catalyst layers gives an SA of 0.45 mA/cm²_{Pt}, which again out-performs other state-of-the-art Pt/C powder catalyst layers (0.27 mA/cm²_{Pt}). Furthermore, for the same number of ALD cycles and similar Pt NP size of 2.2±0.4 nm (FIGS. 16A-B), Pt10/NCS12 still exhibits twice the SA observed for Pt10/NCS85. This surprising improvement in both the MA and SA for the ALD-Pt/NCS12 catalyst is therefore not related to the Pt NP size or the ECSA value, but is most likely the result of differences in the NAFION™/Pt environment, with the ORR-active Pt NPs being isolated and remote from NAFION™.

Further strong evidence for a NAFION™-free environment within much of the ALD-Ptx/NCS12 membranes is shown in FIG. 3C by the significant decrease of ˜50% in the HUPD charge for ALD-Pt10/NCS12 at lower relative humidities (RH) in the MWA. This is a reliable indicator of the % dry proton accessibility, considered to be a sign that the Pt NPs are located near, but not are blocked by, the NAFION™. The dry proton accessibility of 50% for Pt/NCS12 catalyst indicates that more than half of the Pt NPs can access protons through some other means, most likely through adsorbed water. In contrast, essentially no change in the HUPD charge is observed with changes in RH for Pt10/NCS85 (FIG. 3D), where nearly all of the Pt NPs are in full contact with NAFION™ [16].

TABLE 5
Summary of ORR Kinetic Activity of ALD-Pt10/NCS Catalyst Layers Compared to Literature Reports

| | Mass | Specific | Tafel | Measurement | |
|---|---|---|---|---|---|
| | Activity* | Activity* | Slope | Conditions | |
| Sample | (A/mg_{Pt}) | (mA/cm²_{Pt}) | (mV/dec) | (all at 80° C., 100% RH) | Ref. |
| ALD-Pt7/NCS12 | 0.42 | 0.44 | 91 | H₂/O2 (500/5000 sccm) | present |
| | | | | 150 kPa_{abs} | disclosure |
| ALD-Pt10/NCS12 | 0.58 ± 0.1 | 0.45 ± 0.01 | 84 ± 4 | H₂/O2 (500/5000 sccm) | present |
| | | | | 150 kPa_{abs} | disclosure |
| ALD-Pt20/NCS12 | 0.32 | 0.27 | 107 | H₂/O2 (500/5000 sccm) | present |
| | | | | 150 kPa_{abs} | disclosure |
| ALD-Pt10/NCS85 | 0.19 | 0.20 | 82 | H₂/O2 (500/5000 sccm) | present |
| | | | | 150 kPa_{abs} | disclosure |
| Pt/Ketjen Black_{TKK} | 0.37 ± 0.03 | 0.45 ± 0.03 | 88 ± 1 | H₂/O2 (2000/5000 sccm) | [17] |
| | | | | 170 kPa_{abs} | |
| Pt/Ketjen Black_{IW} | 0.25 ± 0.001 | 0.31 ± 0.004 | 85 ± 2 | H₂/O2 (2000/5000 sccm) | [17] |
| | | | | 170 kPa_{abs} | |
| Pt/Ketjen Black | 0.42 ± 0.01 | — | 71 ± 1 | H₂/O2 (1000/2000 nccm) | [25] |
| (600° C.) | | | | 230 kPa_{abs} | |
| DOE Target | 0.44 | — | — | 150 kP_{abs} | www.energy.gov |

*All activities measured at 0.9 V (IR-corrected) in MEA configuration.

These results are surprising, especially because the NAFION™-free proton transport length in the NCS12 spheres is quite large. As the inter-connected NAFION™ coating appears to envelop all of the 0.9-1 μm diameter spheres, protons must be able to access the Pt NPs via the 12 nm pores from essentially any point on the sphere surfaces and reach the center of the spheres (˜500 nm distance) to achieve the observed ˜100% Pt utilization. Several other studies have argued in support of proton transport through water during the ORR in MEAs in the absence of NAFION™, but only over significantly shorter distances [7,35-38]. In Pt NP-decorated mesoporous carbons, [1-5, 7, 8] the good ORR activity observed during cell operation was proposed to be achieved by proton transport over distances of 30-50 nm through liquid water generated by the ORR. In other work, Gasteiger et al. [26] assumed that water adsorbed on the inner surface of the 50-100 nm long mesopores of Ketjen Black conducts protons through the carbon particles. Yarlagadda and coworkers [18] found that mesoporous carbon with Pt NPs inside 4-7 nm pores, too narrow for NAFION™ to penetrate, generated a high MA of 0.36 A/mg_{Pt}. They also attributed this to proton transport via water through the 40-50 nm long pores, thus protecting Pt from ionomer poisoning However, these distances are much shorter than the distances from the surfaces to the centers of the porous bodies (spheres) of the NCS membranes.

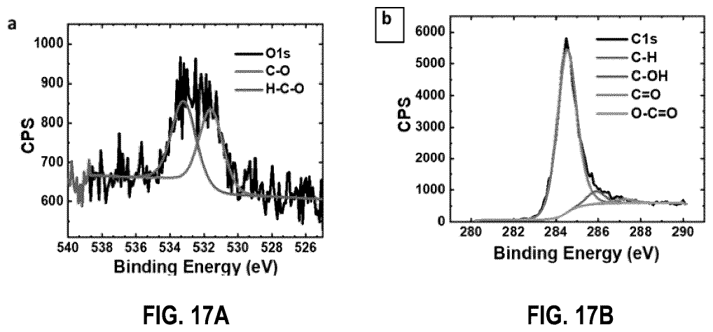

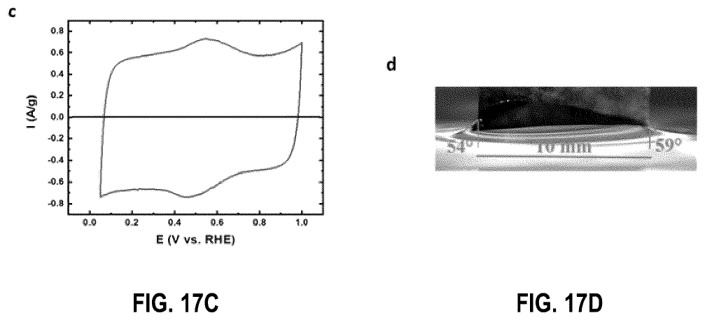

Without being bound to any particular theory, one possible model to explain the excellent ORR activity of ALD-Pt/NCS12 in the absence of accessible ionomer, even in much longer pores, involves proton transport facilitated by a contiguous ultra-thin ALD-produced layer of Pt that connects neighboring Pt NPs [39]. However, it is challenging to verify the presence of such an atomically thin Pt film. Further, given the very different response of the Pt/NCS85 and Pt/NCS12 catalyst layers to RH (FIGS. 3C-3D), both involving ALD-Pt, the hypothesized thin film structure of Pt within the NCS12 spheres does not seem likely. A more likely explanation for the remarkable proton transport characteristics within the spheres is linked to the unusually high density of surface oxygen-functionalities on the NCS12 material, resulting in pronounced internal hydrophilicity (see Tables 6-8, FIGS. 17A-D) [23, 40, 41]. Compared to conventional carbon supports employed in PEMFCs, the coverage of oxygen-containing functional groups on the surface of the NCS12 is much higher. For instance, the concentration of the oxygen groups is 6 times higher in NCS12 than KB-300J, measured using temperature-programmed desorption (TPD) analysis under the same conditions (Table 6) [34, 42].

TABLE 6
Amount of Gas Released from NCS12 Films and
Ketjen Black Powder During TPD Analysis

| Sample | H₂ (μmol/g) | H₂O (μmol/g) | CO (μmol/g) | CO₂ (μmol/g) |
|---|---|---|---|---|
| NCS12 | 3106 | 454 | 1019 | 207 |
| KB-300J | 979 | 52 | 187 | 25 |
| [34] | | | | |

These oxygen-rich surfaces will then readily deprotonate within the thin layer of water formed in the humidified MEA environment, producing a high density of negative surface charge, which will facilitate proton transport along the pore length. This hypothesis would then explain the surprising ease of proton transport observed during the ORR in the kinetic region over NAFION™-free lengths of 400-500 nm, extending from the surfaces to the cores of the spheres, while also explaining the marked sensitivity of Pt10/NCS12 to RH (FIG. 3C).

TABLE 7
Elemental Composition and Functional Groups on the Surfaces
of the NCS12 Films Obtained from XPS Analysis

| | | Component and | |
|---|---|---|---|
| Element | Conc. (at. %) | Conc. (at. %)* | Binding Energy (eV) |
| C | 96.22% | C-II (91.3%) | 284.5 |
| | | C—OH (6.29%) | 285.88 |
| | | C═O (2.42%) | 287.2 |
| O | 3.78% | C═O (50.01%) | 531.6 |
| | | C—O (49.99%) | 533.6 |

*The percentage of each component was estimated from deconvolution of the high-resolution C1s or O1s x-ray photoelectron spectrum.

TABLE 8
Physical and Electrochemical Properties of Pt10/NCS12
Catalyst Layer, Determined in an MEA at Beginning
of Life (BOL) and End of Life (EOL)

| | Particle Size | ECSA | Mass Activity | Specific Activity |
|---|---|---|---|---|
| Sample | (nm) | (m²/g) | (A/mg_{Pt}) | (mA/cm²) |
| BOL | 2.4 | 122 | 0.69 | 0.44 |
| EOL | 5.0 | 54 | 0.68 | 1.27 |

### Example 7. Retention of ORR Kinetics After Accelerated Durability Testing

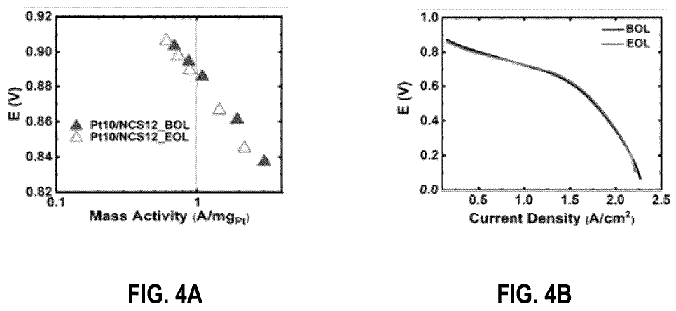

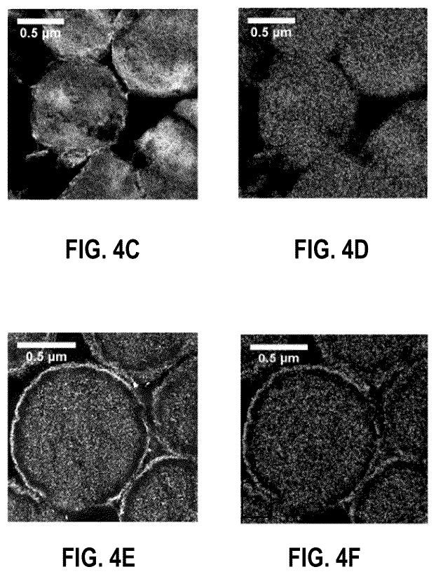

To investigate the long-term performance of our ALD-Pt/NAFION™/NCS12 catalyst layers, 100% RH accelerated durability testing (ADT) was applied to the best performing Pt10/NCS12 cathodes, following the DOE protocol. [43] Referring to Table 8, despite the loss of ECSA by 58% (compared to 43% demonstrated by a commercial CCM tested under the same ADT conditions [44] at end of life (EOL)), the ORR kinetics and MEA performance were maintained almost fully compared to at beginning of life (BOL) (FIGS. 4A-4B). Acceptable voltage losses of <20 mV are seen in the kinetic region, and a current density of >0.4 A/cm+ is retained at 0.8 V at EOL.

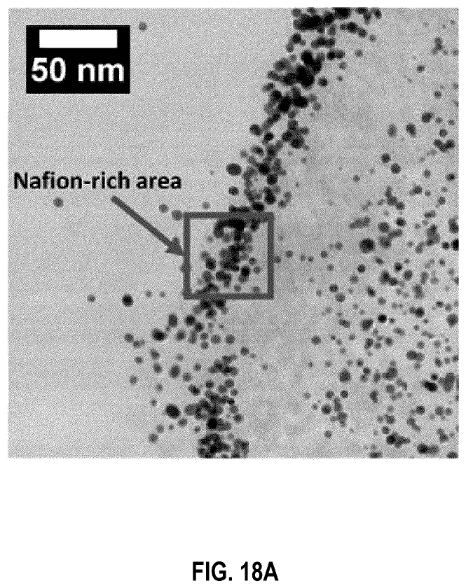

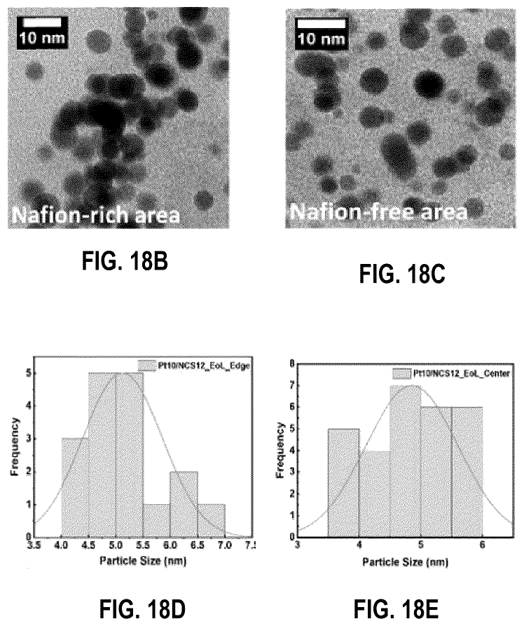

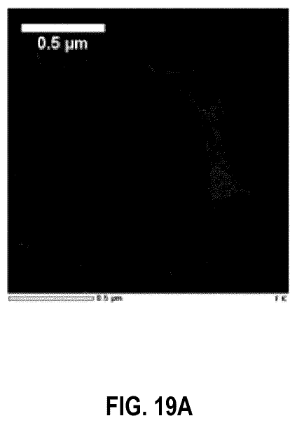

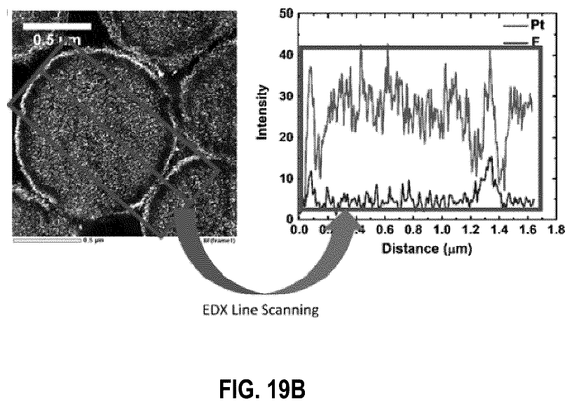

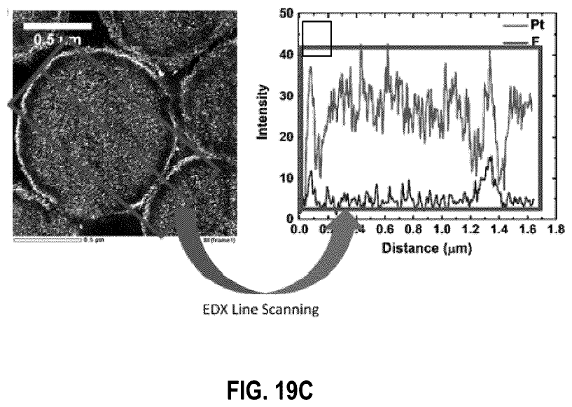

Referring to FIGS. 19A-C, TEM analysis shows ripening of the Pt NPs after ADT, with an increasing size seen both inside and on the surface of the NCS12 spheres. Further evidence for Pt aggregation was obtained by comparing the TEM images in FIG. 13B with those in FIGS. 18A-C, showing that the average Pt particle size increased from ˜2.4 nm at BOL to 4.5-5 nm at EOL, consistent with the ECSA drop (Table 8). HR-TEM further reveals that, at EOL, the Pt particles near the surface of the NCS12 spheres, close to where the ionomer resides, are larger (5.1 nm) than deeper inside the spheres, leaving a region just below the sphere skin that is Pt-depleted (FIGS. 19A-C). This suggests that the NPs in the sub-surface region are particularly prone to particle migration and ripening, in agreement with the Pt EDX mapping (FIGS. 4C-F). These fine details would be very difficult to distinguish in traditional catalyst systems, where Pt NPs tethered to the surface of randomly located carbon particles are intermingled with surrounding ionomer. In the present work, one can clearly discern the fate of the Pt NPs within the spheres of the ordered Pt/NCS12 catalyst layer, while also being certain that NAFION™ and Pt remain well-shielded from each other.

Despite the fact that an increase in Pt NP size should decrease the surface-to-volume ratio, this can be compensated for by an increase in the surface density of more catalytically active Pt facets (“the particle size effect”), thus increasing the MA. This phenomenon, reached when Pt NP are ˜5 nm in size. [44-46]. Other factors that may help to retain the MA and SA include: (i) that, in the water-only environment inside the spheres, Pt dissolution may be minimized by the less aggressive pH of the water film versus NAFION™, as well as the absence of the NAFION™ sulfonate group, which could promote Pt²⁺ formation; and (ii) the Pt NPs may be stabilized inside the spheres at EOL (FIGS. 19A-C) by the rich density of oxygen-rich sites on the NCS12 surface, while also being protected due to their location, nested inside the carbon mesopores.

### REFERENCES

The following documents and publications are referenced with numerals within brackets [#] above and are incorporated herein by reference in their entirety:
[1] Jiang, F., Wang, C.-Y. & Chen, K. S., Current Ramping: A Strategy for Rapid Start-up of PEMFCs from Subfreezing Environment, 157 J. ELECTROCHEM. SOC. B342 (2010).
[2] Alaswad, A. et al., Developments in fuel cell technologies in the transport sector, 41 INT'L J. HYDROGEN ENERGY 16499-16508 (2016).
[3] Wilberforce, T., Alaswad, A., Palumbo, A., Dassisti, M. & Olabi, A. G., Advances in stationary and portable fuel cell applications, 41 INT'L J. HYDROGEN ENERGY 16509-22 (2016).
[4] Xue, L. et al., Zigzag carbon as efficient and stable oxygen reduction electrocatalyst for proton exchange membrane fuel cells, 9 NATURE COMMUN. 1-8 (2018).
[5] Kongkanand, A. & Mathias, M. F., The Priority and Challenge of High-Power Performance of Low-Platinum Proton-Exchange Membrane Fuel Cells, 7 J. PHYS. CHEM. LETT. 1127-37 (2016).
[6] Yoshida, T. & Kojima, K., Toyota MIRAI fuel cell vehicle and progress toward a future hydrogen society, 24 ELECTROCHEM. SOC'Y INTERFACE 45-49 (2015).
[7] Kodama, K., Nagai, T., Kuwaki, A., Jinnouchi, R. & Morimoto, Y., Challenges in applying highly active Pt-based nanostructured catalysts for oxygen reduction reactions to fuel cell vehicles, 16 NATURE NANOTECHNOL. 140-47 (2021).
[8] Banham, D. et al., Critical advancements in achieving high power and stable nonprecious metal catalyst-based MEAs for real-world proton exchange membrane fuel cell applications, 4 SCI. ADV. eaar7180 (2018).
[9] Breitwieser, M., Klingele, M., Vierrath, S., Zengerle, R. & Thiele, S., Tailoring the Membrane-Electrode Interface in PEM Fuel Cells: A Review and Perspective on Novel Engineering Approaches, 8 ADV. ENERGY MATER. 1701257 (2018).
[10] Banham, D., Feng, F., Pei, K., Ye, S. & Birss, V., Effect of carbon support nanostructure on the oxygen reduction activity of Pt/C catalysts, 1 J. MATER. CHEM. A 2812-20 (2013).
[11] Kodama, K. et al., Catalyst Poisoning Property of Sulfonimide Acid Ionomer on Pt (111) Surface, 161 J. ELECTROCHEM. SOC'Y F649-F652 (2014).
[12] Shinozaki, K., Morimoto, Y., Pivovar, B. S. & Kocha, S. S., Suppression of oxygen reduction reaction activity on Pt-based electrocatalysts from ionomer incorporation, 325 J. POWER SOURCES 745-51 (2016).
[13] Masuda, T., Sonsudin, F., Singh, P. R., Naohara, H. & Uosaki, K., Potential-dependent adsorption and desorption of perfluorosulfonated ionomer on a platinum electrode surface probed by electrochemical quartz crystal microbalance and atomic force microscopy, 117 J. PHYS. CHEM. C 15704-09 (2013).
[14] Subbaraman, R., Strmcnik, D., Paulikas, A. P., Stamenkovic, V. R. & Markovic, N. M., Oxygen reduction reaction at three-phase interfaces, 11 CHEMPHYSCHEM 2825-33 (2010).
[15] Suzuki, T., Kudo, K. & Morimoto, Y., Model for investigation of oxygen transport limitation in a polymer electrolyte fuel cell, 222 J. POWER SOURCES 379-89 (2013).
[16] Debe, M. K., Electrocatalyst approaches and challenges for automotive fuel cells, 486 NATURE 43-51 (2012).
[17] Sinha, P. K., Gu, W., Kongkanand, A. & Thompson, E., Performance of Nano Structured Thin Film (NSTF) Electrodes under Partially-Humidified Conditions, 158 J. ELECTROCHEM. SOC'Y B831 (2011).
[18] Yarlagadda, V. et al., Boosting Fuel Cell Performance with Accessible Carbon Mesopores, 3 ACS ENERGY LETT. 618-21 (2018).
[19] Kabir, S. et al., Elucidating the Dynamic Nature of Fuel Cell Electrodes as a Function of Conditioning: An ex Situ Material Characterization and in Situ Electrochemical Diagnostic Study, 11 ACS APPL. MATER. INTERFACES 45016-30 (2019).
[20] Dull, S. M. et al., Bottom-Up Fabrication of Oxygen Reduction Electrodes with Atomic Layer Deposition for High-Power-Density PEMFCs, 2 CELL REPORTS PHYS. SCI. 100297 (2021).
[21] Banham, D. et al., Novel Mesoporous Carbon Supports for PEMFC Catalysts, 5 CATALYSTS 1046-67 (2015).
[22] Ji, X., Lee, K. T. & Nazar, L. F., A highly ordered nanostructured carbon-sulphur cathode for lithium-sulphur batteries, 8 NATURE MATER. 500-06 (2009).
[23] Atwa, M. et al., Scalable nanoporous carbon films allow line-of-sight 3D atomic layer deposition of Pt: towards a new generation catalyst layer for PEM fuel cells, 8 MATER. HORIZONS 2451-62 (2021).
[24] Thommes, M. et al., IUPAC Technical Report Physisorption of gases, with special reference to the evaluation of surface area and pore size distribution (IUPAC Technical Report), 87 PURE APPL. CHEM. 1051-69 (2015).
[25] Rao, V. et al., The influence of carbon support porosity on the activity of PtRu/Sibunit anode catalysts for methanol oxidation, 145 J. POWER SOURCES 178-87 (2005).
[26] Harzer, G. S., Orfanidi, A., El-Sayed, H., Madkikar, P. & Gasteiger, H. A., Tailoring Catalyst Morphology towards High Performance for Low Pt Loaded PEMFC Cathodes, 165 J. ELECTROCHEM. SOC'Y F770-F779 (2018).
[27] Prasanna, M., Cho, E. A., Lim, T. H. & Oh, I. H., Effects of MEA fabrication method on durability of polymer electrolyte membrane fuel cells, 53 ELECTROCHIM. ACTA 5434-41(2008).
[28] Vidal-Iglesias, F. J., Arán-Ais, R. M., Solla-Gullón, J., Herrero, E. & Feliu, J. M., Electrochemical Characterization of Shape-Controlled Pt Nanoparticles in Different Supporting Electrolytes, 2 ACS CATAL. 901-10 (2012).
[29] Clavilier, J., Faure, R., Guinet, G. & Durand, R., Preparation of monocrystalline Pt microelectrodes and electrochemical study of the plane surfaces cut in the direction of the {111} and {110} planes, 107 J. ELECTROANAL. CHEM. 205-09 (1980).
[30] Devivaraprasad, R. et al., Oxygen Reduction Reaction and Peroxide Generation on Shape-Controlled and Polycrystalline Platinum Nanoparticles in Acidic and Alkaline Electrolytes, 30 LANGMUIR 8995-9006 (2014).
[31] Markovie, N. M., Gasteiger, H. A. & Ross, P. N., Oxygen Reduction on Platinum Low-Index Single-Crystal Surfaces in Sulfuric Acid Solution: Rotating Ring-Pt(hkl) Disk Studies, 99 PHYS. CHEM. 3410-15 (1995).
[32] Clavilier, J., The role of anion on the electrochemical behaviour of a {111} platinum surface; an unusual splitting of the voltammogram in the hydrogen region, 107 J. ELECTROANAL. CHEM. INTERFACIAL ELECTROCHEM. 211-16 (1980).
[33] Kamat, G. A. et al., Acid anion electrolyte effects on platinum for oxygen and hydrogen electrocatalysis, 5 COMMUN. CHEM. 1-10 (2022).
[34] Ott, S. et al., Ionomer distribution control in porous carbon-supported catalyst layers for high-power and low Pt-loaded proton exchange membrane fuel cells, 19 NATURE MATER. 77-85 (2020).
[35] Liu, W. J., Wu, B. L. & Cha, C. S., Surface diffusion and the spillover of H-adatoms and oxygen-containing surface species on the surface of carbon black and Pt C porous electrodes, 476 J. ELECTROANAL. CHEM. 101-08 (1999).
[36] Liu, J. & Zenyuk, I. V., Proton transport in ionomer-free regions of polymer electrolyte fuel cells and implications for oxygen reduction reaction, 12 CURR. OPIN. ELECTROCHEM. 202-08 (2018).
[37] Hu, L., Zhang, M., Komini Babu, S., Kongkanand, A. & Litster, S., Ionic Conductivity over Metal/Water Interfaces in Ionomer-Free Fuel Cell Electrodes, 6 CHEMELECTROCHEM 2659-66 (2019).
[38] Chan, K. & Eikerling, M., A Pore-Scale Model of Oxygen Reduction in Ionomer-Free Catalyst Layers of PEFCs, 158 J. ELECTROCHEM. SOC'Y B18 (2011).
[39] Debe, M. K., Tutorial on the Fundamental Characteristics and Practical Properties of Nanostructured Thin Film (NSTF) Catalysts, 160 J. ELECTROCHEM. SOC'Y F522 (2013).
[40] Pan, B. et al., Spontaneous Imbibition Dynamics of Liquids in Partially-Wet Nanoporous Media: Experiment and Theory, 137 TRANSP. POROUS MEDIA 555-74 (2021).
[41] Pan, B. et al., Wetting dynamics of nanoliter water droplets in nanoporous media, 489 J. COLLOID INTERFACE SCI. 411-23 (2021).
[42] Tang, R. et al., Insight into the origin of carbon corrosion in positive electrodes of supercapacitors, 7 J. MATER. CHEM. A 7480-88 (2019).
[43] Ohma, A., Shinohara, K., Iiyama, A., Yoshida, T. & Daimaru, A., Membrane and Catalyst Performance Targets for Automotive Fuel Cells by FCCJ Membrane, Catalyst, MEA WG, 41 ECS TRANS. 775-84 (2019).
[44] Xu, S. et al., Direct Integration of Strained-Pt Catalysts into Proton-Exchange-Membrane Fuel Cells with Atomic Layer Deposition, 33 ADV. MATER. 2007885 (2021).
[45] Ko, M., Padgett, E., Yarlagadda, V., Kongkanand, A. & Muller, D. A., Revealing the Nanostructure of Mesoporous Fuel Cell Catalyst Supports for Durable, High-Power Performance, 168 J. ELECTROCHEM. SOC'Y 024512 (2021).
[46] O'Brien, T. E. et al., Impact of Carbon Support Structure on the Durability of PtCo Electrocatalysts, 168 J. ELECTROCHEM. SOC'Y 054517 (2021).
[47] U.S. Pat. No. 10,258,932.
[48] Islam, M. N. et al., Highly Ordered Nanoporous Carbon Scaffold with Controllable Wettability as the Microporous Layer for Fuel Cells, 12 ACS APPL. MATER. INTERFACES 39215-26 (2020).
[49] Ishii, T. et al., A quantitative analysis of carbon edge sites and an estimation of graphene sheet size in high-temperature treated, non-porous carbons, 80 CARBON 135-45 (2014).
[50] Zhang, J., Litteer, B., Corns, F. & Makharia, R. R., Recoverable Performance Loss due to Membrane Chemical Degradation in PEM Fuel Cells, 41 ECS TRANS. 1471-85 (2019).

What is claimed is:

1. A supported catalyst system, comprising:
a bimodal porous support, the support comprising:
a plurality of porous bodies connected by interconnecting structures,
wherein the porous bodies have primary pores throughout their structures, the primary pores defined by a first average pore diameter; and
wherein the spaces between the interconnected porous bodies define secondary pores having a second average pore diameter; and
catalyst deposits within the primary pores.

2. The supported catalyst system according to claim 1, wherein the catalyst deposits comprise one or more platinum group metals.

3. The supported catalyst system according to claim 1, wherein the catalyst deposits comprise Pt.

4. The supported catalyst system according to claim 1, wherein the first average pore diameter is less than or equal to 20 nm.

5. The supported catalyst system according to claim 1, wherein the first average pore diameter is 8 nm to 20 nm.

6. The supported catalyst system of claim 1, wherein the second average pore diameter is greater than 20 nm.

7. The supported catalyst system of claim 1, wherein the second average pore diameter is 100 nm to 500 nm.

8. The supported catalyst system of claim 1, wherein the porous bodies have a diameter of 500 nm to 1.5 μm.

9. The supported catalyst system of claim 1, wherein the porous bodies comprise a carbonaceous material.

10. The supported catalyst system of claim 1, wherein the primary pores within a porous body are interconnected and have an average neck diameter of 2 nm to 8 nm.

11. The supported catalyst system of claim 1, wherein the interconnecting structures comprise carbon fibers.

12. The supported catalyst system of claim 1, further comprising an ionomer, wherein the ionomer does not contact the catalyst deposits inside the primary pores.

13. The supported catalyst system of claim 12, wherein the ionomer is located on outer surfaces of the porous bodies and the interconnecting structures but not within the primary pores.

14. The supported catalyst system of claim 12, wherein the ionomer comprises a tetrafluoroethylene-based fluoropolymer.

15. The supported catalyst system of claim 1, wherein the supported catalyst system has a surface area of greater than or equal to 500 mm²/g, determined by BET analysis.

16. The supported catalyst system of claim 1, wherein the supported catalyst system has an average mass-normalized ORR activity (MA) of greater than or equal to 0.44 A/mgPt at 0.9 V.

17. A membrane electrode assembly, comprising:
a gas diffusion layer;
a polymer electrolyte membrane; and
the supported catalyst system according claim 1 disposed between the gas diffusion layer and the polymer electrolyte membrane.

18. A method of making a supported catalyst system, comprising:
providing a bimodal porous support, the support comprising:
a plurality of porous bodies connected by interconnecting structures,
wherein the porous bodies have primary pores throughout their structures, the primary pores defined by a first average pore diameter; and
wherein the spaces between the interconnected porous bodies define secondary pores having a second average pore diameter; and
depositing catalyst deposits within the primary pores.

19. The method of claim 18, wherein the depositing is performed using atomic layer deposition.

20. The method according to claim 18, wherein the catalyst deposits comprise one or more platinum group metals.
